(19) United States
(12) Patent Application Publication
(10) Pub. No.: US 2025/0350660 A1
(43) Pub. Date: Nov. 13, 2025

(54) Machine Sensor Configuration System

(71) Applicant: Caterpillar Inc., Peoria, IL (US)

(72) Inventors: Arjun Veneshetty, Dunlap, IL (US); John D. Parker, Dunlap, IL (US); Joseph Andrew Willenborg, Dunlap, IL (US); Li Zhang, Dunlap, IL (US)

(73) Assignee: Caterpillar Inc., Peoria, IL (US)

(21) Appl. No.: 18/658,773

(22) Filed: May 8, 2024

(51) Int. Cl. H04L 67/12; G01P 1/07

(52) U.S. Cl. CPC H04L 67/12; G01P 1/07

(57) ABSTRACT

A sensor associated with a machine has a configuration trigger that, when activated, causes the sensor to enter a configuration mode. When the sensor is in the configuration mode, the sensor broadcasts identification data indicating a sensor address of the sensor, such as a MAC address. A controller of the machine may use the sensor address, included in the identification data broadcast by the sensor, to update a sensor configuration in order to configure the controller to recognize the sensor as being associated with the machine.

### TECHNICAL FIELD

The present disclosure relates to a controller of a machine that wirelessly receives data from sensors and, more particularly, to configuring the controller to recognize identifiers of particular sensors.

### BACKGROUND

Machines, such as haul trucks and other work machines, may perform various operations at worksites or other environments. As an example, a haul truck may be loaded with material at a first location, and may transport the material to a second location.

Sensors may be associated with components of a machine. Such sensors may take measurements, make other types of determinations, or otherwise determine sensor data. The sensors may wirelessly transmit sensor data to other systems, such as a computing system on-board the machine.

Various systems have been developed in the past to manage sensors associated with machines. For example, U.S. Pat. No. 9,493,043 to Yu et al. (hereinafter “Yu”) describes a system in which a setting tool with a display and a user interface can be used to configure a tire pressure sensor, associated with a particular vehicle tire, with a location code corresponding to the particular vehicle tire. In Yu's system, the tire pressure sensor may then provide that location code and an identifier of the tire pressure sensor to a main unit of the vehicle. However, the system described by Yu may rely on a separate setting tool that is compatible with tire pressure sensors, and may have limited abilities to manage other types of sensors associated with a machine.

Examples of the present disclosure are directed to overcoming the deficiencies noted above.

### SUMMARY

According to a first aspect of the present disclosure, a method includes receiving, by a controller of a machine, identification data indicating a sensor address of a sensor. The method includes determining, by the controller, that the sensor was likely in a configuration mode at a time at which the sensor broadcast the identification data, based on activation of a configuration trigger of the sensor. The method includes adding, by the controller, and based on determining that the sensor was likely in the configuration mode, an entry to a sensor configuration maintained by the controller. The entry includes the sensor address indicated by the identification data, and causes the controller to process subsequent sensor data indicating the sensor address.

According to a second aspect of the present disclosure, a method includes determining, by a sensor associated with a machine, activation of a configuration trigger of the sensor. The method includes switching, by the sensor, and based on the activation of the configuration trigger, from a normal operation mode to a configuration mode. The method includes broadcasting, by the sensor, and while the sensor is in the configuration mode, identification data that indicates a sensor address of the sensor. The identification data causes a controller of the machine to update a sensor configuration to include an entry for the sensor address of the sensor.

According to a third aspect of the present disclosure, a system includes a controller of a machine, and a sensor associated with the machine. The controller is configured to maintain a sensor configuration indicating sensor addresses of individual sensors associated with the machine. The controller is also configured to receive sensor data broadcast by sensors. The controller is also configured to process instances of the sensor data that indicate the sensor addresses included in the sensor configuration. The controller is also configured to receive identification data broadcast by the sensors. The controller is also configured to update the sensor configuration based on instances of the identification data broadcast while the sensors are in a configuration mode. The sensor includes a configuration trigger. Activation of the configuration trigger temporarily switches the sensor to operate in the configuration mode and causes the sensor to broadcast an instance of the identification data that indicates a sensor address of the sensor. The instance of the identification data broadcast by the sensor, while the sensor is in the configuration mode, causes the controller to update the sensor configuration by adding an entry including the sensor address of the sensor.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 shows an example of a machine sensor configuration system in which a controller of a machine is configured to wirelessly communicate with one or more sensors associated with the machine.

FIGS. 2A and 2B show an example in which a first machine may be proximate to other machines, such as a second machine and/or a third machine, at a worksite or other environment.

FIG. 3 is a flowchart illustrating an example process a sensor may use to broadcast identification data while in a configuration mode.

FIG. 4 is a flowchart illustrating an example process a controller of a machine may use to recognize a sensor based on received identification data.

FIG. 5 is a flowchart illustrating an example process by which a controller of a machine may be configured to recognize a sensor associated with the machine.

FIG. 6 is a flowchart illustrating an example process a controller of a machine may use to detect a dormant sensor or a replacement sensor based on received identification data.

FIG. 7 is a flowchart illustrating an example process by which a controller of a machine may be configured to recognize a sensor associated with the machine and a mounting location of the sensor on the machine.

FIG. 8 is a flowchart illustrating an example process in which a sensor may be configured with a mounting location, and may indicate the mounting location in identification data broadcast while the sensor is in a configuration mode.

FIG. 9 shows an example system architecture for a sensor.

FIG. 10 shows an example system architecture for a controller.

### DETAILED DESCRIPTION

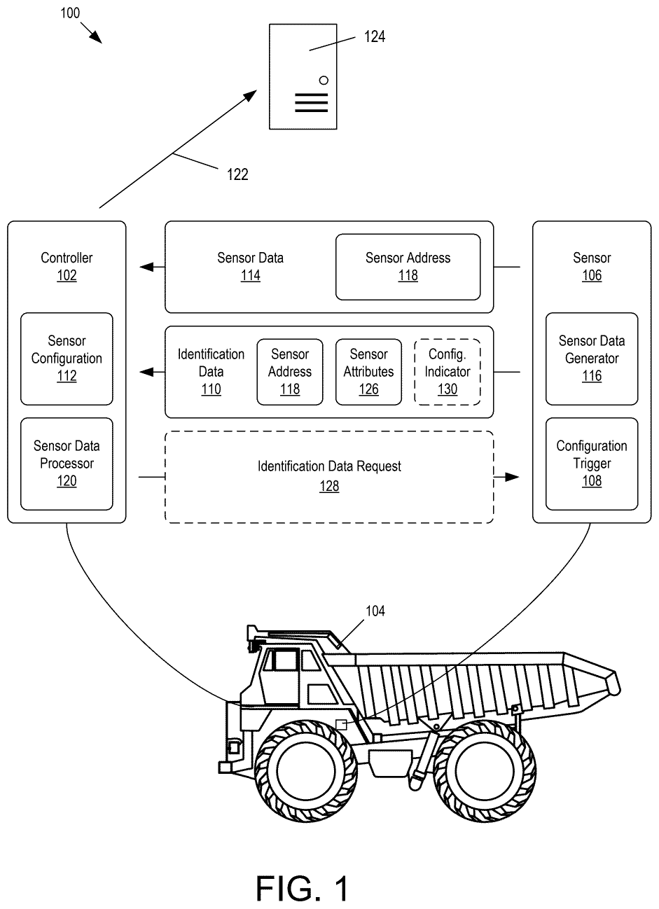

FIG. 1 shows an example of a machine sensor configuration system 100 in which a controller 102 of a machine 104 is configured to wirelessly communicate with one or more sensors 106 associated with the machine 104. The sensors 106 may have respective configuration triggers 108 that, if activated, at least temporarily cause the sensors 106 to enter a configuration mode. When a configuration trigger 108 of a sensor 106 is activated, the sensor 106 may at least temporarily switch from a normal operation mode to the configuration mode, and may broadcast identification data 110 while in the configuration mode. The controller 102 may receive the identification data 110 broadcast by the sensor 106, and may use the identification data 110 to update a sensor configuration 112 maintained by the controller 102. The controller 102 may use the sensor configuration 112 to receive and/or interpret sensor data 114 sent by the sensor 106.

The machine 104 may be a commercial or work machine, such as a vehicle, a piece of heavy machinery, a piece of industrial equipment, or any other type of machine. For example, the machine 104 may be a mining machine, earth-moving machine, backhoe, scraper, dozer, loader (e.g., large wheel loader, track-type loader, etc.), shovel, truck (e.g., mining truck, haul truck, on-highway truck, off-highway truck, articulated truck, tanker, etc.), a crane, a pipe layer, a paver, a compactor, a tractor, farming equipment, or any other type of machine. In some examples, the machine 104 may be a mobile machine or vehicle that may drive or otherwise move around an environment. In other examples, the machine 104 may be a stationary machine that operates while stationary at a fixed location. The machine 104 may, in some situations, operate at a worksite, such as a mine site, a quarry, a construction site, or any other type of worksite or work environment.

The machine 104 may have one or more work tools, such as a bucket, scraper, ripper, blade, pusher, fork, grapple, plow, haul bed, or other type of work tool or implement that the machine 104 may use to perform work operations. For example, the machine 104 may use one or more types of work tools to move and/or otherwise interact with rocks, gravel, dirt, sand, lumber, construction material, and/or any other type of material at a worksite or other environment.

The machine 104 may be a manually-operated staffed machine, a semi-autonomous machine, or an autonomous machine. In examples in which the machine 104 is a staffed machine or a semi-autonomous machine, a human operator or driver may operate, control, or direct some or all of the functions of the machine 104. In examples in which the machine 104 is autonomous or semi-autonomous, functions of the machine 104, such as steering, speed adjustments, work tool positioning and movement, and/or other functions, may be fully or partially controlled, automatically or semi-automatically, by on-board and/or off-board controllers or other computing devices associated with the machine 104.

The controller 102 may be an element of the machine 104, such as an electronic control module (ECM) or other on-board computing system of the machine 104. The sensors 106 and the controller 102 may exchange data wirelessly, for instance via one or more wireless data transmission protocols. For example, a sensor 106 may wirelessly send data to, and/or receive data from, the controller 102 via Bluetooth, Wi-Fi, or other type of wireless data transmission protocols.

The controller 102 and a sensor 106 may broadcast data, and receive broadcasted data that has been broadcast, without a dedicated network connection or other data connection having been established between the controller 102 and the sensor 106. As used herein, the term “broadcast” may indicate that data being broadcast by a sending element is not addressed to a specific receiving element, and accordingly may be received by any compatible receiving element within a transmission range of the sending element. For example, identification data 110 and/or sensor data 114 may be broadcast by a sensor 106 such that any controller 102 of any machine 104 within a transmission range of the sensor 106 may receive the broadcasted identification data 110 and/or sensor data 114, instead the sensor 106 addressing identification data 110 and/or sensor data 114 to a specific controller 102 or the sensor 106 sending the identification data 110 and/or sensor data 114 to a specific controller 102 via a dedicated data connection that has been established between the sensor 106 and the specific controller 102.

The sensors 106 may each have a sensor data generator 116 that is configured to generate and/or broadcast sensor data 114, such as sensor data 114 indicating measurements performed by the sensor 106, determinations made by the sensor 106, or other output of the sensor 106. Accordingly, the sensor data generator 116 of a sensor 106 may generate and/or determine sensor data 114, and cause the sensor 106 to broadcast that sensor data 114 via a wireless data transmission protocol. The controller 102 may receive the sensor data 114 broadcast by the sensor 106, and process the received sensor data 114 as described further below.

The sensors 106 may each be associated with a unique sensor address 118. Sensor addresses 118 of the sensors 106 may be unique identifiers of those sensors 106, such as Media Access Control (MAC) addresses, serial numbers, or other sensor identifiers. For example, a particular sensor 106 may be associated with a corresponding MAC address, such as a particular alphanumeric string of hexadecimal characters.

The sensors 106 may indicate the sensor addresses 118 of those sensors 106 in and/or along with the sensor data 114 broadcast by the sensors 106. For example, the sensor addresses 118 of the sensors 106 may be stored in memory of the sensors 106, and/or may be encoded into sensor data generators 116 or other elements of the sensors 106, such that the sensors 106 are configured to indicate those sensor addresses 118 in and/or along with sensor data 114 that the sensors 106 broadcast.

The sensors 106 may include one or more types of sensors. In some examples, the sensors 106 may include one or more types of sensors that may be temporarily or permanently mounted at positions on the exterior and/or the interior of the machine 104. For instance, some sensors 106 may be at least temporarily installed on, coupled to, affixed to, or otherwise connected to elements of the machine 104, such as a body of the machine 104, a work tool of the machine 104, an internal or external component of the machine 104, or any other element of the machine 104.

In other examples, the sensors 106 may also, or alternately, include one or more types of sensors that may be removable from the machine 104 and/or that transportable by users or other elements separately from the machine 104. For instance, a sensor 106 may be a wireless key fob associated with the machine 104 that may be transported by an operator of the machine 104, and may thus be carried by the operator into a cab of the machine 104 when the operator uses the machine 104 and carried away from the machine 104 when the operator is done using the machine 104.

The sensor data generators 116 of some types of sensors 106 may be configured to measure and/or determine attributes associated with one or more components of the machine 104, such as positional data, temperature data, and/or other measurements. Such sensors 106 may accordingly broadcast sensor data 114 that indicates values of measurements and/or other determinations made by the sensors 106. For example, the sensors 106 may include a work tool sensor that is configured to measure or determine a position and/or orientation of a work tool of the machine 104, a temperature sensor that is configured to measure a temperature of an engine, drivetrain element, or other component of the machine 104, a fuel level sensor configured to determine a current fuel level of the machine 104, a track wear sensor that measures a depth of a tread on a track of the machine 104, a tire pressure sensor configured to measure pressure of a tire of the machine 104, an oil cap sensor configured to measure an oil level associated with an engine of the machine 104, a battery sensor configured to monitor a state-of-health, state-of-charge, and/or other parameters of a battery of the machine 104, such as a traction battery for a hybrid or electric drive machine or a starter battery for a diesel machine, and/or any other type of sensor.

The sensor data generators 116 of other types of sensors 106 may output other types of sensor data 114, such as sensor data 114 indicating predetermined codes or other information. For example, a sensor 106 may be a wireless key fob that transmits a key code, or other sensor data 114, that enables ignition of an engine of the machine 104 and/or enables other operations of the machine 104.

The controller 102 may have a sensor data processor 120 that is configured to recognize sensor data 114 received from one or more sensors 106 based on the sensor configuration 112, and to process and/or interpret the received sensor data 114 based on the sensor configuration 112, as described further below. In some examples, the sensor data processor 120 may locally process and/or interpret one or more types of sensor data 114. In other examples, the sensor data processor 120 may also, or alternately, transmit reports 122 associated with received sensor data 114 to one or more other systems 124. The other systems 124 may be computing systems that are different from the controller 102, such as one or more other computing systems that are on-board the machine 104 and/or one or more computing systems separate from the machine 104, such as a worksite controller, a back office computing system, or a remote system executed by a one or more servers or a cloud computing environment. The controller 102 may, for example, send reports 122 periodically, on-demand, or on any other scheduled or unscheduled basis, to a remote system via a cellular data network, a Wi-Fi connection, or other network or wireless data transmission system.

The reports 122 sent by the controller 102 may include, and/or be based on, sensor data 114 received by the controller 102 from one or more sensors 106. For example, if a track wear sensor on the machine 104 broadcasts sensor data 114 that indicates measurements of a depth of a tread on a track of the machine 104, the controller 102 may receive that sensor data 114 and use the sensor data 114 to periodically send corresponding reports 122 to a remote system that indicate the track tread depths measured by the track wear sensor. The remote system may use the reports 122 to monitor conditions of one or more elements of the machine 104 over a period of time, determine if components of the machine 104 should be fixed or replaced, predict when maintenance or replacement of components of the machine 104 are likely to be needed, track productivity of the machine 104, and/or otherwise use sensor data 114 and/or other information in the provided reports 122.

In some examples, the machine 104 may be able to operate regardless of whether the controller 102 receives sensor data 114 from particular types of sensors 106. For example, although a track wear sensor may be configured to measure tread depths of a track of the machine 104, the machine 104 may in some situations be able to use the track to maneuver around a worksite regardless of whether the track wear sensor is able to measure the current depth of the tread of the track and/or report corresponding sensor data 114 to the controller 102. Accordingly, the sensors 106 may in some examples be optional sensors, aftermarket sensors, and/or other sensors that broadcast sensor data 114 used for monitoring and/or data tracking purposes, for instance via reports 122 that include or are generated based on the sensor data 114, but that may not prevent operations of the machine 104 if sensor data 114 from the sensors 106 is not received by the controller 102.

However, in other examples, some operations of the machine 104 may be conditioned on the controller 102 receiving sensor data 114 from one or more types of sensors 106. For example, if the sensors 106 include one or more wireless key fobs, the controller 102 may prevent some or all operations of the machine 104 until the controller 102 receives a key code or other sensor data 114 from a wireless key fob that is associated with the machine 104.

Sensors 106 may be configured to broadcast sensor data 114 such that any controller 102 on any machine 104 within a transmission range of the sensors 106 may receive the broadcast sensor data 114. For example, if the machine 104 is a first machine 104 that is operating in close proximity to a second machine 104 at a worksite, the controller 102 of the first machine 104 may be within a transmission range of sensors 106 on the second machine 104. Accordingly, the controller 102 of the first machine 104 may receive sensor data 114 broadcast by one or more sensors 106 of the first machine 104, as well as sensor data 114 broadcast by one or more sensors 106 of the second machine 104.

To identify sensor data 114 that has been broadcast by sensors 106 associated with the same machine 104 as the controller 102, instead of sensors 106 associated with other machines 104 or other sensors 106 that the controller 102 has not been configured to recognize, the controller 102 of the machine 104 may maintain the sensor configuration 112 in memory associated with the controller 102. The sensor configuration 112 may be a table, database, or other data that indicates sensor addresses 118 of sensors 106 that the controller 102 is currently configured to recognize. For example, the sensor configuration 112 maintained by the controller 102 of the machine 104 may identify MAC addresses and/or other identifiers of sensors 106 that the controller 102 has been configured to recognize as being associated with the machine 104.

The sensor configuration 112 maintained by the controller 102 of the machine 104 may also indicate sensor attributes 126 that correspond to respective sensor addresses 118. The sensor attributes 126 that correspond to the sensor addresses 118 of sensors 106 may indicate attributes and/or capabilities of those sensors 106, such as types of the sensors 106, data formats or schemas used by the sensors 106, types of sensor data 114 that the sensors 106 are able to determine and/or transmit, hardware and/or software capabilities of the sensors 106, manufacturers of the sensors 106, mounting locations of the sensors 106 on the machine 104, version numbers of the sensors 106, and/or any other information about the sensors 106.

Accordingly, when the controller 102 receives sensor data 114 broadcast by a sensor 106, the controller 102 may use the sensor configuration 112 to determine if a sensor address 118 indicated by the received sensor data 114 is included in the sensor configuration 112 maintained by the controller 102. If the sensor address 118 indicated by the received sensor data 114 is included in the sensor configuration 112, the controller 102 may determine that the controller 102 has been configured to recognize the sensor 106 associated with that sensor address 118. The controller 102 may also use the sensor attributes 126, associated with the sensor address 118 in the sensor configuration 112, to interpret and/or process the received sensor data 114 that is associated with the sensor address 118, for instance via the sensor data processor 120. However, if a sensor address 118 indicated by received sensor data 114 is not in the sensor configuration 112, the controller 102 may discard or ignore that received sensor data 114 because the controller 102 has not been configured to recognize the sensor 106 associated with that sensor address 118.

As an example, the sensor configuration 112 may include a first sensor address 118 of a work tool sensor that the controller 102 has been configured to recognize as being associated with the machine 104. The sensor configuration 112 may also include a second sensor address 118 of a tire pressure sensor that the controller 102 has been configured to recognize as being associated with the machine 104.

In this example, if the controller 102 receives first sensor data 114 that identifies the first sensor address 118 in the sensor configuration 112, the controller 102 may use the sensor configuration 112 to determine that the first sensor data 114 is from the work tool sensor that the controller 102 has previously been configured to recognize. The sensor data processor 120 of the controller 102 may also process and/or interpret the first sensor data 114 based on sensor attributes 126 in the sensor configuration 112 that correspond to the first sensor address 118. For example, because the sensor attributes 126 in the sensor configuration 112 may indicate that the first sensor address 118 corresponds to a work tool sensor that uses a first schema to report positional information regarding a work tool of the machine 104, the sensor data processor 120 of the controller 102 may process the first sensor data 114 as work tool positional data that is formatted according to the first schema.

Similarly, if the controller 102 receives second sensor data 114 that identifies the second sensor address 118 in the sensor configuration 112 in this example, the controller 102 may use the sensor configuration 112 to determine that the second sensor data 114 is from the tire pressure sensor that the controller 102 has previously been configured to recognize. The sensor data processor 120 of the controller 102 may also process and/or interpret the second sensor data 114 based on sensor attributes 126 in the sensor configuration 112 that correspond to the second sensor address 118. For example, because the sensor attributes 126 in the sensor configuration 112 may indicate that the second sensor address 118 corresponds to a tire pressure sensor that uses a second schema to report tire pressure information regarding a particular tire of the machine 104, the sensor data processor 120 of the controller 102 may process the second sensor data 114 as tire pressure data that is formatted according to the second schema and that indicates a current tire pressure of the particular tire.

However, in this example, if the controller 102 receives third sensor data 114 that identifies a third sensor address 118 that is not present in the sensor configuration 112 maintained by the controller 102, the controller 102 may ignore or discard the third sensor data 114. In this situation, the third sensor address 118 may correspond with a sensor 106 that is associated with a different machine, or a sensor 106 that the controller 102 has otherwise not been configured to recognize as being associated with the machine 104. For instance, the third sensor address 118 may correspond with a sensor 106 on a different machine that is currently at a location that close enough to the machine 104 such that third sensor data 114 broadcast by the that sensor 106 on the different machine can be received by the controller 102 of the machine 104. Accordingly, the third sensor address 118 may not be included in the sensor configuration 112 maintained by the controller 102 of the machine 104, because the controller 102 of the machine 104 has not been configured to recognize the sensor 106 on the different machine. Because the third sensor address 118 is not included in the sensor configuration 112 maintained by the controller 102 in this example, the controller 102 may discard and/or ignore the third sensor data 114 that identifies the third sensor address 118.

In some situations, the sensor configuration 112 maintained by the controller 102 may be, or become, incomplete or out of date. For example, when a new sensor 106 is added to the machine 104, the sensor configuration 112 maintained by the controller 102 may not yet include the sensor address 118 of the new sensor 106.

However, the sensors 106 may have configuration triggers 108 that may be activated to update the sensor configuration 112 maintained by the controller 102. Activation of a configuration trigger 108 of a sensor 106 may cause the sensor 106 to at least temporarily switch from a normal operation mode to a configuration mode. For example, activation of the configuration trigger 108 of a sensor 106 may cause the sensor 106 to be in the configuration mode for thirty seconds, sixty seconds, or any other period of time, before returning to the normal operation mode. While in the configuration mode, the sensor 106 may broadcast identification data 110 that indicates the sensor address 118 of the sensor 106. Accordingly, the controller 102 may receive the identification data 110 indicating the sensor address 118 of the sensor 106, determine that the sensor address 118 is not yet in the sensor configuration 112, and may accordingly add the sensor address 118 to the sensor configuration 112 such that the controller 102 becomes configured to recognize the sensor 106 based on the sensor address 118.

Sensors 106 may have one or more types of configuration triggers 108 that cause the sensors 106 to at least temporarily switch from a normal operation mode into the configuration mode. In some examples, a configuration trigger 108 of a sensor 106 may be a software trigger or other digital trigger that is activated automatically in response to receipt of activation data. For example, as described further below, the controller 102 may broadcast an identification data request 128 in some situations or examples, and the identification data request 128 from the controller 102 may be activation data that automatically activates the configuration trigger 108 of a sensor 106.

As another example, activation data that automatically activates the configuration trigger 108 of a sensor 106 may be provided by a user device, such as a service tool, mobile computing device, laptop computer, or other device used by a technician or other user. For instance, the configuration trigger 108 of a sensor 106 may be automatically activated via a Near Field Communication (NFC) signal from an NFC tag or other NFC-enabled device, via a signal from a handheld service tool or other device transmitted wirelessly via Bluetooth or other transmission protocols, or via a signal from a handheld service tool or other device that is connected to the sensor 106 via a jumper cable or another wired connection.

In other examples, a configuration trigger 108 of a sensor 106 may be a hardware trigger, physical trigger, or other trigger that may be activated manually, physically, and/or locally by a technician or other user. As an example, a configuration trigger 108 of a sensor 106 may be a physical button, a capacitive touch sensor, a resistive touch sensor, another type of touch sensor, or other type of physical control element that a user can activate by pushing the configuration trigger 108, touching the configuration trigger 108, or providing other physical input to the configuration trigger 108. As another example, a configuration trigger 108 of a sensor 106 may include an accelerometer or other motion sensor, such that a user can activate the configuration trigger 108 by tapping, shaking, or otherwise moving the sensor 106 in a way that is detected by the accelerometer or other motion sensor as an activation of the configuration trigger 108. As another example, a configuration trigger 108 of a sensor 106 may include a magnetic sensor, such that a user can activate the configuration trigger 108 by tapping the sensor 106 with a magnetized wand or other magnetized component, or otherwise using a magnetized wand or other magnetized component in a way that is detected by the magnetic sensor as an activation of the configuration trigger 108.

When a configuration trigger 108 of a sensor 106 has not been activated and the sensor 106 is in a normal operation mode, the sensor 106 may broadcast sensor data 114 as discussed above. For example, the sensor 106 may broadcast sensor data 114 at periodic intervals, when information measured or determined by the sensor 106 matches threshold criteria, and/or at other times. In some examples, the sensor 106 may also periodically or occasionally broadcast identification data 110 while the sensor 106 is in the normal operation mode. For instance, in the normal operation mode, the sensor 106 may periodically broadcast identification data 110 that indicates the sensor address 118 of the sensor 106, for instance as a heartbeat message or other notification that may indicate to the controller 102 that the sensor 106 associated with the sensor address 118 is active and/or working properly even if the sensor 106 is not broadcasting sensor data 114. However, because the controller 102 of the machine 104 may be within a transmission range of sensors 106 on other machines, and/or other sensors 106 that the controller 102 has not been configured to recognize, the controller 102 may normally ignore identification data 110 that include sensor addresses 118 that are not in the sensor configuration 112 maintained by the controller 102.

However, if the configuration trigger 108 of a sensor 106 is activated and the sensor 106 enters the configuration mode, the sensor 106 can broadcast identification data 110 that causes the controller 102 to update the sensor configuration 112 maintained by the controller 102. For example, when the sensor 106 is in the configuration mode and broadcasts identification data 110 that includes the sensor address 118 of the sensor 106, the controller 102 may receive the identification data 110 and add the sensor address 118 indicated by the identification data 110 to the sensor configuration 112 if the sensor address 118 is not yet present in the sensor configuration 112. Accordingly, identification data 110 sent by a sensor 106 that is in the configuration mode may cause the controller 102 to detect the sensor 106 and to become configured to recognize the sensor 106 as being associated with the machine 104.

The identification data 110 broadcast by a sensor 106 may include indications of one or more sensor attributes 126 of the sensor 106. For example, in addition to the sensor address 118 of the sensor 106, the identification data 110 may also indicate one or more attributes and/or capabilities of the sensor 106, such as a type of the sensor 106, a data format or schema used by the sensor 106, a type of sensor data 114 that the sensor 106 broadcasts, hardware and/or software capabilities of the sensor 106, a manufacturer of the sensors 106, a mounting location of the sensor 106 on the machine 104, a version number of the sensor 106, and/or any other information about the sensor 106. Accordingly, when the controller 102 updates the sensor configuration 112 based on identification data 110 that indicates a sensor address 118 that had not yet been in the sensor configuration 112, the controller 102 may also update the sensor configuration 112 to associate the newly-added sensor address 118 with corresponding sensor attributes 126 indicated by the identification data 110.

In some examples, the controller 102 may update the sensor configuration 112 to indicate sensor attributes 126 of a sensor 106 that are derived or inferred by the controller 102 based on the sensor address 118 and/or other sensor attributes 126 indicated directly by the identification data 110. For example, if the identification data 110 does not indicate a sensor type, but the sensor address 118 indicated by the identification data 110 is a MAC address that falls within a range of MAC addresses that is used for sensors 106 of a particular sensor type, the controller 102 may infer that the sensor 106 is an instance of that particular sensor type. The controller 102 may accordingly update the sensor configuration 112 to indicate that the sensor address 118 is associated with an instance of that particular sensor type, even though the identification data 110 did not directly specify the particular sensor type.

As noted above, the controller 102 may normally ignore identification data 110 that include sensor addresses 118 that are not in the sensor configuration 112 maintained by the controller 102. However, the controller 102 may be configured to determine whether it is likely that received identification data 110 was broadcast by a sensor 106 while that sensor 106 was in the configuration mode. If the controller 102 determines that received identification data 110 was likely to have been broadcast by a sensor 106 while the sensor 106 was in the configuration mode, the controller 102 may update the sensor configuration 112 based on the received identification data 110, for instance to add a sensor address 118 indicated by the received identification data 110 that was not previously in the sensor configuration 112 and/or to add corresponding sensor attributes 126 indicated by the received identification data 110.

The controller 102 may, in some examples, be configured to determine that received identification data 110 should be used to update the sensor configuration 112 if the identification data 110 has a configuration indicator 130. The sensors 106 may be configured to omit the configuration indicator 130 from identification data 110 that the sensor 106 broadcasts while in the normal operation mode. However, when a sensor 106 switches from the normal operation mode to the configuration mode in response to activation of the configuration trigger 108 of the sensor 106, the sensor 106 may be configured to indicate a configuration indicator 130 within identification data 110 that the sensor 106 broadcasts while in the configuration mode.

In some examples, the configuration indicator 130 may be a configuration flag, configuration code, a header value, and/or other type of data that the sensor 106 adds to the identification data 110 that indicates that the identification data 110 was sent while the sensor 106 was in the configuration mode. Accordingly, the identification data 110 the sensor 106 sends in the configuration mode may be similar to identification data 110 the sensor 106 sends in the normal operation mode, aside from the inclusion of the configuration indicator 130 when the sensor 106 is in the configuration mode. In other examples, the configuration indicator 130 may be a different data type or format for identification data 110 the sensor 106 uses while in the configuration mode, relative to a data type or format for the identification data 110 the sensor 106 uses while in the normal operation mode.

Accordingly, if the controller 102 receives identification data 110 with a sensor address 118 that is not in the sensor configuration 112, but the identification data 110 has the configuration indicator 130, the controller 102 may determine to update the sensor configuration 112 based on the sensor address 118 and/or the sensor attributes 126 indicated by the identification data 110. In some situations or examples, if the controller 102 receives identification data 110 with a sensor address 118 that is not in the sensor configuration 112, and the identification data 110 does not have the configuration indicator 130, the controller 102 may determine to ignore the identification data 110.

However, the controller 102 may also, or alternately, be configured to determine that received identification data 110 should be used to update the sensor configuration 112 if the identification data 110 is received within a threshold period of time after the controller 102 broadcasts an identification data request 128. The identification data request 128 may be a message or notification that causes the configuration triggers 108 of sensors 106 to activate, such that those sensors 106 enter the configuration mode.

In some examples, as discussed above, the sensors 106 may broadcast identification data 110 that has the configuration indicator 130 when the sensors 106 are in the configuration mode. Accordingly, the controller 102 may use any identification data 110 that has the configuration indicator 130, and is received by the controller 102 within a threshold period of time after the controller 102 sends the identification data request 128, to update the sensor configuration 112.

In other examples, when sensors 106 are in the configuration mode in response to receipt of the identification data request 128 from the controller 102, the sensors 106 may lower a transmission power used to broadcast the identification data 110. In these examples, the identification data 110 broadcast by sensors 106 at lowered transmission power levels while the sensors 106 are in the configuration mode may omit the configuration indicator 130, or may have the configuration indicator 130.

The sensors 106 may be configured to use a relatively high transmission power while the sensors 106 are in the normal operation mode, such that the transmission range of the identification data 110 broadcast by the sensors 106 may be relatively large. Accordingly, the transmission range of identification data 110 broadcast when sensors 106 of a machine 104 are in the normal operation may be large enough to encompass other machines, such that controllers of those machines may receive the identification data 110.

However, when sensors 106 are in the configuration mode in response to an identification data request 128, the sensors 106 may use a lower transmission power to broadcast corresponding identification data 110 than is used in the normal operation mode, in order to reduce the transmission range of the identification data 110 broadcast by the sensors 106. Lowering the transmission power a sensor 106 uses to broadcast identification data 110 while the sensor 106 is in the configuration in response to an identification data request 128, and thereby reducing the transmission range of the identification data 110 broadcast by the sensor 106, may reduce the likelihood of that identification data 110 being received by controllers of other machines. Accordingly, when a sensor 106 uses reduced transmission power to broadcast identification data 110 in response to an identification data request 128 sent by the controller 102, the controller 102 may receive the sensor configuration 112 and use the identification data 110 to detect the sensor 106 and update the sensor configuration 112 even if the identification data 110 from the sensor 106 omits the configuration indicator 130 because the reduced transmission power may make it unlikely that controllers of other machines may receive the identification data 110 from the sensor 106.

In some examples, when the controller 102 broadcasts the identification data request 128, the controller 102 may at least temporarily reduce a power level the controller 102 uses to listen for identification data 110 that has been broadcast by sensors 106. For example, when the controller 102 broadcasts the identification data request 128, the controller 102 may reduce the power level used to listen for identification data 110 for thirty seconds, sixty seconds, or any other period of time. By reducing the power level used to listen for identification data 110 during a period of time after the controller 102 broadcasts the identification data request 128, the controller 102 may reduce the chances of receiving identification data 110 broadcast by sensors 106 associated with other machines.

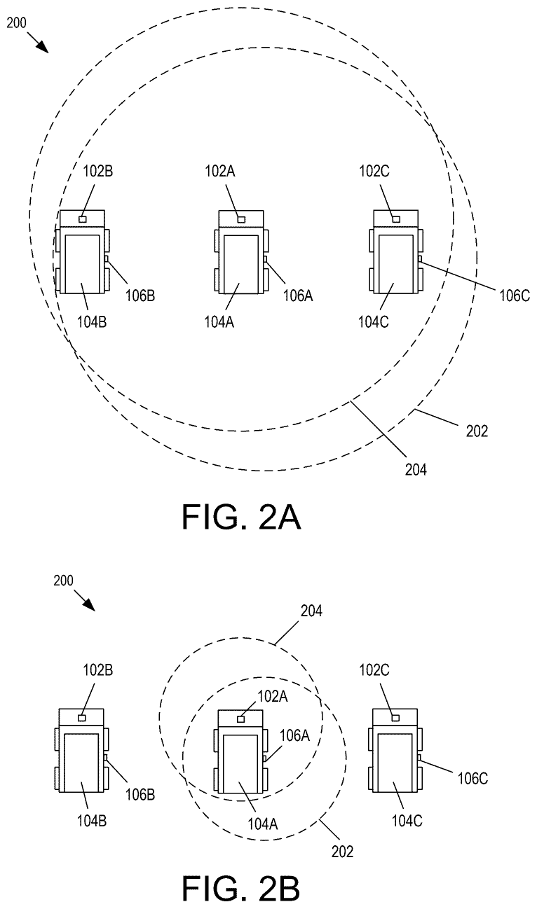

Accordingly, when a sensor 106 uses reduced transmission power to broadcast identification data 110 in response to an identification data request 128 sent by the controller 102, and/or the controller 102 uses reduced power to listen for such identification data 110, the controller 102 may use received identification data 110 to update the sensor configuration 112 even if the identification data 110 omits a configuration indicator 130, because the reduced power levels used in response to the identification data request 128 may make it unlikely that identification data 110 received by the controller 102 is from a sensor 106 on a different machine. Reduction of such power levels used to broadcast and/or listen for identification data 110, in response to an identification data request 128, is discussed further below with respect to FIGS. 2A and 2B.

The controller 102 may be configured to broadcast the identification data request 128 based on the occurrence of one or more conditions. As an example, the controller 102 may be configured to broadcast the identification data request 128 if the controller 102 has not received sensor data 114 associated with a sensor address 118 listed in the sensor configuration 112 for more than a threshold period of time.

For instance, the sensor configuration 112 may include a particular sensor address 118 associated with a particular sensor 106. However, if no identification data 110 or sensor data 114 corresponding to that particular sensor address 118 has been received by the controller 102 in the last 40 machine operating hours, or any other shorter or longer threshold period of time, the lack of data received from the particular sensor 106 over the threshold period of time may indicate that the particular sensor 106 has been replaced on the machine 104. Accordingly, the controller 102 may broadcast the identification data request 128 in order to cause a replacement instance of the particular sensor 106, if present on the machine 104, to enter the configuration mode. If such a replacement sensor 106 is present on the machine 104, the replacement sensor 106 may broadcast identification data 110 indicating the sensor address 118 and/or sensor attributes 126 of the replacement sensor 106, and the controller 102 may use that identification data 110 to detect the replacement sensor 106 and update the sensor configuration 112 so that the sensor data processor 120 can begin recognizing and processing sensor data 114 broadcast by the replacement sensor 106.

As another example, the controller 102 may be configured to broadcast the identification data request 128 if the controller 102 determines that the machine 104 is traveling at a speed that meets or exceeds a threshold speed. For instance, in some examples, the controller 102 may use speed data provided by a speed sensor, motion, location, or positional data provided by an accelerometer, a Global Positioning System (GPS) sensor, or other sensors, and/or other types of data to determine when the machine 104 is in motion and is traveling at a speed that meets or exceeds the threshold speed. Accordingly, when the controller 102 determines that the speed of the machine 104 meets or exceeds the threshold speed, the controller 102 may broadcast the identification data request 128 to cause any or all of the sensors 106 currently on the machine 104 to enter configuration modes and broadcast corresponding identification data 110. The controller 102 may use that identification data 110 to detect any or all of the sensors 106 that are currently on the machine 104 and that broadcasted identification data 110 in response to the speed-triggered identification data request 128. The controller 102 may also use the received identification data 110 to automatically update the sensor configuration 112, for instance to add sensor addresses 118 and/or sensor attributes 126 for any or all of the sensors 106 currently on the machine 104 that were not already indicated by the sensor configuration 112.

In examples in which the identification data request 128 may be triggered by a speed of the machine 104, the sensors 106 may also be configured to enable or disable software-based configuration triggers 108, that are configured to be activated based on identification data requests 128, based on similar detections of the speed of the machine 104 by the sensors 106. For example, to preserve battery life of a sensor 106 and/or reduce energy consumption by the sensor 106, the sensor 106 may be configured to disable listening for identification data requests 128 when an accelerometer of the sensor 106 indicates that the sensor 106, and thus the machine 104, is stationary. However, if the accelerometer of the sensor 106 indicates that the sensor 106, and thus the machine 104, is in motion, such that there is a chance that the controller 102 may broadcast an identification data request 128 based on a speed of the machine 104, the sensor 106 may enable active listening for an identification data request 128 that would activate a configuration trigger 108 of the sensor 106.

In some examples, sensor attributes 126 of a sensor 106 indicated in the sensor configuration 112 may indicate a mounting location of the sensor 106, such that the controller 102 may determine where the sensor 106 is located on the machine 104 and/or distinguish between multiple sensors 106 of the same type that are located at different locations on the machine 104. As an example, sensor attributes 126 of a particular sensor 106 indicated in the sensor configuration 112 may indicate that the particular sensor 106 is located at or near a front end of the machine 104, a rear end of the machine 104, a right side of the machine 104, on a left side of the machine 104. As another example, if the machine 104 has multiple wheels or tires, the sensor attributes 126 of a particular sensor 106 indicated in the sensor configuration 112 may indicate which of those wheels or tires the particular sensor 106 is located at or near.

In some of these examples, the sensor attributes 126 included in identification data 110 that is broadcast by a sensor 106 while the sensor 106 is in the configuration mode may accordingly indicate the mounting location of that sensor 106. Accordingly, the controller 102 may use the sensor attributes 126 in received identification data 110 to determine a mounting location of a sensor 106 indicated by the identification data 110, and update the sensor configuration 112 to indicate the mounting location of the sensor 106.

In these examples, when a technician installs a sensor 106 at a particular mounting location on the machine 104, the technician may interact with the sensor 106 to configure the sensor 106 with location data identifying the particular mounting location of the sensor 106 on the machine 104. As an example, if the sensor 106 could be mounted on the left side or the right side of the machine 104, the technician may use one or more controls on the sensor 106, such as a toggle switch, a button, a touch sensor, or other control, to indicate whether the sensor 106 is actually mounted on the left side or the right side of the machine 104. For instance, the technician may press a button on the sensor 106 one time to indicate that the sensor 106 is mounted on the left side of the machine 104, or press the button on the sensor 106 two times to indicate that the sensor 106 is mounted on the right side of the machine 104. The sensor 106 may have memory that stores the mounting location data configured by the technician via the controls of the sensor 106. As another example, a technician may use a service tool, mobile computing device, laptop computer, or other device that interfaces with the sensor 106 to provide user input identifying the mounting location of the sensor 106, such that the sensor 106 may store corresponding mounting location data in memory of the sensor 106.

Accordingly, in such examples in which the sensor 106 is configured with mounting location data, in memory of the sensor 106, indicating the mounting location of the sensor 106, the sensor 106 may include that mounting location data or otherwise indicate the mounting location of the sensor 106 in sensor attributes 126 included in identification data 110 broadcast by the sensor 106. For example, if a user manually activates a configuration trigger 108 of the sensor 106, or if the controller 102 broadcasts an identification data request 128 that activates a configuration trigger 108 of the sensor 106, the sensor 106 may enter the configuration mode and broadcast identification data 110 that includes sensor attributes 126 indicating the mounting location of the sensor 106 on the machine 104. The controller 102 may use the sensor attributes 126 in the identification data 110 to update the sensor configuration 112 to indicate the mounting location of the sensor 106 on the machine 104.

In other examples, a technician or other user may use a user interface of the controller 102, or a user interface of another device that interfaces with the controller 102, to select a particular mounting location. User input may also, in some examples, indicate a user-selected sensor type associated with the sensor at the user-selected mounting location. Selection of the particular mounting location by the user may cause the controller 102 to interpret the next-received identification data 110 that has the configuration indicator 130 as being from a sensor 106 that is mounted at the user-selected sensor mounting location. The user may then activate the configuration trigger 108 of the sensor 106 at the user-selected sensor mounting location, to cause that sensor 106 to enter the configuration mode and to broadcast identification data 110 that has the configuration indicator 130. The controller 102 may accordingly receive that identification data 110, and use the identification data 110 to update the sensor configuration 112 with the sensor address 118 and/or sensor attributes 126 of the sensor 106, including an indication that the corresponding sensor 106 is located at the user-selected sensor mounting location and/or is an instance of a user-selected sensor type.

As an example, a technician may use a user interface of the controller 102 or an associated device to indicate that a track wear sensor associated with the left track of the machine 104 is being configured. The controller 102 may accordingly begin listening for identification data 110 that has a configuration indicator 130. The technician may then press a button on, or otherwise manually interact with, a track wear sensor that has been, or will be, installed on the machine 104 in association with the left track of the machine 104, in order to activate a configuration trigger 108 of that track wear sensor. Manual activation of the configuration trigger 108 of the track wear sensor may cause the track wear sensor to enter the configuration mode and begin broadcasting identification data 110 that indicates the sensor address 118 and/or sensor attributes 126 of the track wear sensor. The identification data 110 broadcast by the track wear sensor can also have the configuration indicator 130, such that the controller 102 can determine that the identification data 110 was sent by a sensor 106 that is in the configuration mode, likely due to a manual activation of the configuration trigger 108 by the technician. The controller 102 may accordingly associate the identification data 110 with the user-selected track wear sensor type and the user-selected left track location, and use the identification data 110 to correspondingly update the sensor configuration 112 with an entry for a track wear sensor associated with the user-selected left track location.

Accordingly, even if the sensor attributes 126 included in the identification data 110 broadcast by the track wear sensor do not directly indicate that the track wear sensor is associated with the left track of the machine 104, the controller 102 can determine that the identification data 110 is associated with a track wear sensor associated with the left track based on the user selection of the left track location. Similarly, if the sensor attributes 126 included in the identification data 110 broadcast by the track wear sensor do not directly indicate that the corresponding sensor 106 is a track wear sensor, the controller 102 can determine that the identification data 110 is associated with a track wear sensor associated based on the user selection of the track wear sensor type.

In some examples, the controller 102 may be configured to update the sensor configuration 112 based on identification data 110 associated with a particular sensor 106 of interest. As an example, as discussed above, the controller 102 may receive input via a user interface or other system that identifies a sensor type and/or a mounting location of a sensor 106, such that the controller 102 is configured to interpret the next received identification data 110 as being from a sensor 106 with attributes corresponding to the input. However, in some situations the controller 102 may receive instances identification data 110 broadcast by multiple sensors 106 during a period of time in which the controller 102 expects to receive identification data 110 associated with a particular sensor 106. As discussed above, in some examples the controller 102 may determine which identification data 110 corresponds with a particular sensor 106 of interest based on sensor type information, mounting location information, and/or other types of information indicated by sensor attributes 126 within the identification data 110. However, in other examples, the controller 102 may use a number of instances of identification data 110 received from corresponding sensors 106, and/or determine which instance of identification data 110 has the latest timestamp, when determining which instance of identification data 110 should be considered to be from a particular sensor 106 of interest.

As an example, if the controller 102 is expecting to receive identification data 110 from a sensor 106 of interest, but receives identification data 110 from multiple sensors 106 that could each potentially be the sensor 106 of interest, the controller 102 may determine how many packets or copies of identification data 110 were received from each of those multiple sensors 106. The controller 102 may be configured to interpret the sensor 106 that broadcasted the highest number of packets or copies of identification data 110 as the sensor 106 of interest, and may use the identification data 110 from that sensor 106 to update the sensor configuration 112. If that highest number of packets or copies of identification data 110 was received from multiple sensors 106, for instance if the multiple sensors 106 each broadcast an equal number of packets of identification data 110, the controller 102 may use timestamp information indicating when individual copies or packets of identification data 110 were broadcasted and/or received to determine which of the multiple sensors 106 provided the most recent and freshest identification data 110. In this situation, the controller 102 may be configured to interpret the sensor 106 that broadcasted the most recent and freshest identification data 110 as the sensor 106 of interest, and may use the identification data 110 from that sensor 106 to update the sensor configuration 112.

Overall, when the configuration trigger 108 of a sensor 106 is activated, for example manually based on direct or indirect input by a technician or other user, or automatically based on an identification data request 128 from the controller 102, the sensor 106 may enter the configuration mode. While in the configuration mode the sensor 106 may broadcast identification data 110 that has the configuration indicator 130 and/or is sent by the sensor 106 at a low transmission power, such that the sensor 106 can determine that the identification data 110 was likely sent by the sensor 106 while the sensor 106 was in the configuration mode. If the sensor 106 determines that the identification data 110 was likely sent by the sensor 106 while the sensor 106 was in the configuration mode, the controller 102 can use the sensor address 118 and/or the sensor attributes 126 included by the sensor 106 in the identification data 110 to update the sensor configuration 112 maintained by the controller 102.

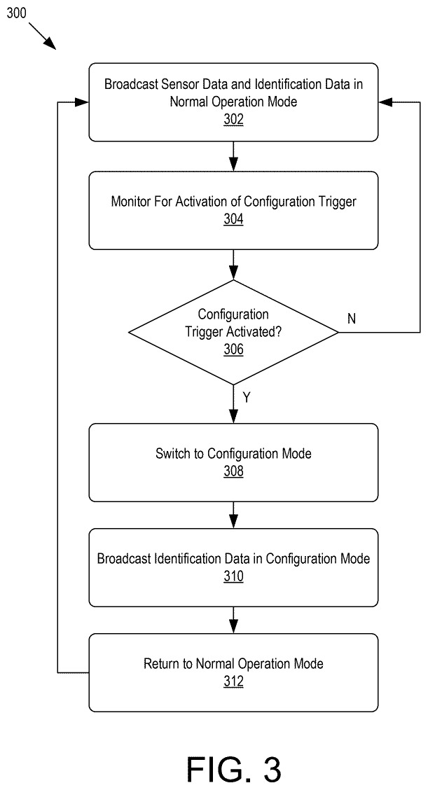

As example of a sensor 106 broadcasting identification data 110 using low transmission power in response to an identification data request 128 from the controller 102 is discussed further below with respect to FIG. 2A and FIG. 2B. Additional examples of sensors 106 broadcasting identification data 110 while in the configuration mode, and/or the controller 102 using such identification data 110 to update the sensor configuration 112, are discussed further below with respect to FIGS. 3-8.

FIGS. 2A and 2B show an example 200 in which a first machine 104A may be proximate to other machines, such as a second machine 104B and/or a third machine 104C, at a worksite or other environment. The first machine 104A may have a first controller 102A and may be associated with a first sensor 106A. For example, the first sensor 106A may be a sensor that is mounted to, or otherwise installed on, the first machine 104A. Similarly, the second machine 104B may have a second controller 102B and may be associated with a second sensor 106B, while the third machine 104C may have a third controller 102C and may be associated with a third sensor 106C.

The first sensor 106A may broadcast sensor data 114 and/or identification data 110 within a sensor range area 202 associated with the first sensor 106A, and/or listen for identification data requests 128 from controllers 102 that are within the sensor range area 202. The first machine 104A may similarly receive sensor data 114 and/or identification data 110 that has been broadcast by sensors 106 that are within a controller range area 204 associated with the first sensor 106A, and/or broadcast identification data requests 128 within the controller range area 204.

The sizes of the sensor range area 202 and the controller range area 204 may vary depending on respective power levels used by the first sensor 106A and the first machine 104A. For example, when the first sensor 106A is in a normal operation mode, the first sensor 106A may use a first level of transmission power to broadcast sensor data 114 and/or identification data 110 within a relatively large sensor range area 202 as shown in FIG. 2A. However, when the first sensor 106A switches to the configuration mode in response to an identification data request 128, the first sensor 106A may use a lower second level of transmission power in order to reduce the size of the sensor range area 202 and broadcast identification data 110 within that smaller sensor range area 202 as shown in FIG. 2B.

Similarly, the first controller 102A may normally use a first level of power to listen for sensor data 114 and/or identification data 110 broadcast by sensors 106 located within a relatively large controller range area 204 as shown in FIG. 2A. In some examples, the first controller 102A may also broadcast identification data requests 128 within the relatively large controller range area 204 shown in FIG. 2A. However, after the first controller 102A broadcasts an identification data request 128, the first sensor 106A may use a lower second level of power to reduce the size of the controller range area 204 used to listen for identification data 110 broadcasted by sensors 106 in response to the identification data request 128, as shown in FIG. 2B.

As shown in FIG. 2A, the second controller 102B of the second machine 104B and/or the third controller 102C of the third machine 104C may also be within the relatively large sensor range area 202 that may be associated with the first sensor 106A when the first sensor 106A is in the normal operation mode. Accordingly, when the first sensor 106A is in the normal operation mode, the second controller 102B and/or the third controller 102C may receive sensor data 114 and/or identification data 110 broadcast by the first sensor 106A. However, because the sensor data 114 and/or the identification data 110 broadcast by the first sensor 106A may indicate the sensor address 118 of the first sensor 106A, the second controller 102B and/or the third controller 102C may ignore the sensor data 114 and/or the identification data 110 from the first sensor 106A because the sensor address 118 of the first sensor 106A may not be in sensor configurations 112 maintained by the second controller 102B and/or the third controller 102C.

Similarly, as shown in FIG. 2A, the second sensor 106B of the second machine 104B and/or the third sensor 106C of the third machine 104C may be within the relatively large controller range area 204 that may normally be associated with the first controller 102A. Accordingly, the first controller 102A may receive sensor data 114 and/or identification data 110 broadcast by the second sensor 106B and/or the third sensor 106C. However, because the sensor data 114 and the identification data 110 broadcast by the second sensor 106B and/or the third sensor 106C may indicate respective sensor addresses 118 of the second sensor 106B and the third sensor 106C, the first controller 102A may ignore the sensor data 114 and/or the identification data 110 from the second sensor 106B and the third sensor 106C because the sensor addresses 118 of the second sensor 106B and the third sensor 106C may not be in the sensor configuration 112 maintained by the first controller 102A.

The first sensor 106A on the first machine 104A may also be within the relatively large controller range area 204 associated with the first controller 102A of the first machine 104A, and the first controller 102A may be within the relatively large sensor range area 202 associated with the first sensor 106A. Accordingly, the first controller 102A may receive sensor data 114 and/or identification data 110 broadcast by the first sensor 106A. If the sensor address 118 of the first sensor 106A, included in the sensor data 114 and/or identification data 110 broadcast by the first sensor 106A, is within the sensor configuration 112 maintained by the first controller 102A, the first controller 102A may recognize the first sensor 106A as being associated with the first machine 104A. The first controller 102A may accordingly process and/or use the sensor data 114 and/or identification data 110 received from the first sensor 106A, for instance to provide a corresponding report 122 to a remote system.

However, as described herein, in some examples a sensor configuration 112 maintained by a controller 102 may be incomplete or become out of date. Accordingly, the first controller 102A may be configured to, in some examples or situations, broadcast an identification data request 128 to prompt any or all sensors 106 that are currently on the first machine 104A to switch to the configuration mode and broadcast identification data 110 indicating sensor addresses 118 and/or sensor attributes 126 that the first controller 102A can use to update the sensor configuration 112 maintained by the first controller 102A.

As an example, if the first controller 102A has not received identification data 110 and/or sensor data 114 associated with a particular sensor address 118 in the sensor configuration 112 maintained by the first controller 102A for more than a threshold time, the sensor 106 associated with that particular sensor address 118 may have been replaced on the first machine 104A. Accordingly, the first controller 102A may broadcast an identification data request 128 to prompt a replacement sensor 106 on the first machine 104A, if any, to broadcast corresponding identification data 110 that the first controller 102A may use to update the sensor configuration 112 maintained by the first controller 102A.

As another example, if the first controller 102A detects that the first machine 104A has been stationary but has begun moving, and/or has begun moving at more than a threshold speed, the first controller 102A may broadcast an identification data request 128 to prompt any or all sensors 106 currently on the first machine 104A to broadcast corresponding identification data 110. Accordingly, the first controller 102A may use identification data 110 received in response to the identification data request 128 to update the sensor configuration 112 maintained by the first controller 102A. For instance, if identification data 110 received in response to the identification data request 128 includes new sensor addresses 118 that are not already in the sensor configuration 112, the first controller 102A may determine that those sensor addresses 118 are associated with new sensors 106 that are on, and/or are traveling with, the first machine 104A. The first controller 102A may thus update the sensor configuration 112 to include those sensor address 118 and/or corresponding sensor attributes 126.

As shown in FIG. 2A, the sensor range area 202 and the controller range area 204 associated with the first machine 104A may normally be large enough to encompass other machines, such as second machine 104B and/or third machine 104C. However, to reduce the chances of the first controller 102A of the first machine 104A receiving identification data 110 from sensors 106 on other machines in response to an identification data request 128, the first controller 102A may broadcast the identification data request 128 across a relatively large controller range area 204 as shown in FIG. 2A, but then reduce a power level used to listen for responsive identification data 110 broadcast by sensors 106 located within a smaller controller range area 204 as shown in FIG. 2B. Alternatively, the first controller 102A may use a lower transmission power to broadcast the identification data request 128 across the smaller controller range area 204 shown in FIG. 2B, and then listen for responsive identification data 110 broadcast by sensors 106 located within the smaller controller range area 204 as shown in FIG. 2B.

The first machine 104A may use lower power levels to listen for identification data 110 in response to an identification data request 128 broadcast by the first controller 102A, such that the first controller 102A is likely to only receive identification data 110 broadcast by sensors 106 that are located within the smaller controller range area 204 shown in FIG. 2B. The smaller controller range area 204 shown in FIG. 2B may be large enough to encompass the first machine 104A, but not be large enough to encompass other machines, such as the second machine 104B or the third machine 104C. By using the smaller controller range area 204 to listen for identification data 110 in response to the identification data request 128, the first machine 104A may determine with a relatively high confidence level that any identification data 110 received in response to the identification data request 128 originated from sensors 106 that are currently on the first machine 104A, such as the first sensor 106A, and did not originate from sensors on other machines such as the second sensor 106B or the third sensor 106C.

In some situations or examples, the second sensor 106B on the second machine 104B or the third sensor 106C on the third machine 104C may broadcast respective identification data 110 following a time at which the first controller 102A broadcasts an identification data request 128. However, because the first controller 102A may use the smaller controller range area 204 that does not encompass the second machine 104B or the third machine 104C to listen for identification data 110 after broadcasting an identification data request 128, the first controller 102A may be unlikely to receive the identification data 110 from the second sensor 106B or the third sensor 106C. Accordingly, the first controller 102A may be unlikely to receive identification data 110 from sensors 106 on other machines, or to use such identification data 110 to update the sensor configuration 112 maintained by the first controller 102A, following the broadcast of an identification data request 128.

Similarly, to reduce the chances of identification data 110 broadcast by sensors 106 on a machine in response to an identification data request 128 being received by controllers of other machines, the sensors 106 may be configured to reduce transmission power used to broadcast identification data 110 in response to an identification data request 128. For example, the first sensor 106A may normally broadcast identification data 110 across a relatively large sensor range area 202 as shown in FIG. 2A. However, when the first sensor 106A receives an identification data request 128, the first sensor 106A may switch to the configuration mode and lower transmission power to reduce the size of the sensor range area 202 as shown in FIG. 2B. Accordingly, the first sensor 106A on the first machine 104A may broadcast identification data 110, in response to the identification data request 128, within the smaller sensor range area 202. The smaller sensor range area 202 may encompass the first controller 102A such that if the identification data request 128 originated from the first controller 102A, the first controller 102A may receive the identification data 110 broadcast by the first sensor 106A and may use the identification data 110 to update the sensor configuration 112 maintained by the first controller 102A. However, because the smaller sensor range area 202 does not encompass the second controller 102B of the second machine 104B or the third controller 102C of the third machine 104C, the second controller 102B and the third controller 102C may be unlikely to receive the identification data 110 broadcast by the first sensor 106A in response to the identification data request 128. If the identification data request 128 originated from a controller of a different machine, the identification data 110 broadcast by the first sensor 106A within the smaller sensor range area 202 may be unlikely to reach the controller of the different machine, such that it may be unlikely that the controller of the different machine updates a sensor configuration 112 based on the identification data 110 from the first sensor 106A on the first machine 104A.

In some examples, a sensor 106 on a machine may be configured to only actively listen for, or recognize, identification data requests 128 if accelerometer data or other motion data indicates that the machine is in motion and that receipt of an identification data request 128 may be relatively likely. For example, as discussed above, the first controller 102A of the first machine 104A may be configured to broadcast an identification data request 128 if speed data indicates that the first machine 104A is traveling at more than a threshold speed. The first sensor 106A on first machine 104A may include an accelerometer or other motion sensor data that can determine when the first machine 104A is in motion such that it may be relatively likely that the first controller 102A will broadcast an identification data request 128. Accordingly, to reduce the chances of an identification data request 128 being received from a controller of another machine, and/or to increase the chances of only receiving identification data requests 128 from the first controller 102A of the first machine 104A, the first sensor 106A may be configured to begin listening for identification data requests 128 if accelerometer data or other motion data determined by the first sensor 106A indicates that the first sensor 106A, and thus the first machine 104A, is moving. The first sensor 106A may, for example, use the smaller controller range area 204 shown in FIG. 2B to actively listen for identification data request 128 during times at which the first sensor 106A detects motion.

Overall, by using the smaller sensor range area 202 and/or the smaller controller range area 204 shown in FIG. 2B in some situations, identification data 110 broadcast by a sensor 106 on a machine 104 in response to an identification data request 128 from a controller 102 of that machine 104 may be likely to be received by that controller, but may be unlikely to be received by controllers of other machines. Accordingly, even if the identification data 110 broadcast by a sensor 106 of a machine 104 in response to an identification data request 128 does not have a configuration indicator 130, the increased likelihood of only the controller 102 of the same machine 104 receiving the identification data 110 due to usage of the smaller sensor range area 202 and/or the smaller controller range area 204 may allow the controller 102 to use the identification data 110 to update the sensor configuration 112 maintained by that controller 102, and may decrease the likelihood of controllers of other machines using the identification data 110 to update other respective sensor configurations 112 maintained by the other controllers. Other examples of sensors 106 broadcasting identification data 110, and/or a controller 102 using such identification data 110 to update a sensor configuration 112, are discussed further below with respect to FIGS. 3-8.

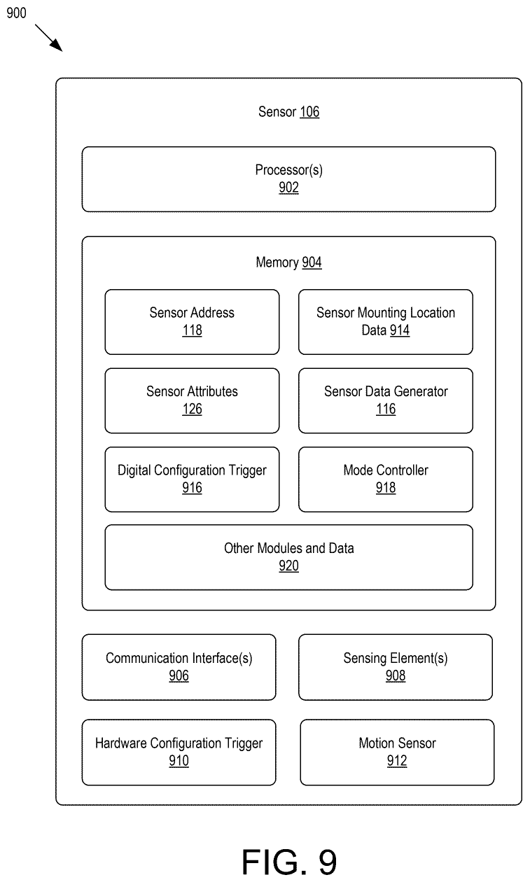

FIG. 3 is a flowchart 300 illustrating an example process a sensor 106 may use to broadcast identification data 110 while in a configuration mode. FIG. 9, discussed further below, describes an example system architecture for such a sensor 106.

At block 302, the sensor 106 may broadcast sensor data 114 and/or identification data 110 while the sensor 106 is in a normal operation mode. For example, when the sensor 106 is in a normal operation mode, the sensor 106 may broadcast sensor data 114 indicating measurements performed by the sensor 106, determinations made by the sensor 106, a key code associated with the sensor 106, or other output of the sensor 106. When the sensor 106 is in the normal operation mode, the sensor 106 may also broadcast identification data 110. In some examples, the identification data 110 the sensor 106 broadcasts while in the normal operation mode may lack the configuration indicator 130, such that the lack of the configuration indicator 130 may indicate that the sensor 106 is in the normal operation mode. The sensor 106 may, in some examples, use a normal transmission power to broadcast the identification data 110 while the sensor 106 is in the normal operation mode, such that the identification data 110 is broadcast within a relatively large sensor range area 202 as shown in FIG. 2A.

At block 304, the sensor 106 may monitor for activation of a configuration trigger 108 of the sensor 106. As an example, the configuration trigger 108 of the sensor 106 may be a physical control, such as a button, a touch sensor, an accelerometer, a magnetic component, or other type of control that a user may selectively activate manually and/or via a magnetic device or other activation tool. As another example, the configuration trigger 108 may be a digital trigger that is activated via a wireless or wired signal from a service tool or other user device, or via an identification data request 128 broadcast by a controller 102 of a machine 104.

At block 306, the sensor 106 may determine whether the configuration trigger 108 has been activated. If the configuration trigger 108 has not been activated (Block 306—No), the sensor 106 may remain in the normal operation mode and return to block 302 to broadcast sensor data 114 and/or identification data 110. However, if the sensor 106 determines that the configuration trigger 108 has been activated (Block 306—Yes), the sensor 106 may switch to the configuration mode at block 308.

At block 310, the sensor 106 may broadcast identification data 110 while the sensor 106 is in the configuration mode. The identification data 110 broadcast at block 310 may include the sensor address 118 of the sensor 106, such as a MAC address that is uniquely associated with the sensor 106. The identification data 110 broadcast at block 310 may also indicate sensor attributes 126 of the sensor 106, such as a type of the sensor 106, a data format or schema used by the sensor 106, a type of sensor data 114 that the sensor 106 broadcasts, hardware and/or software capabilities of the sensor 106, a manufacturer of the sensors 106, a mounting location of the sensor 106 on the machine 104, a version number of the sensor 106, and/or any other information about the sensor 106.

In some examples, the identification data 110 broadcast at block 310 while the sensor 106 is in the configuration mode may have the configuration indicator 130, to signify to a receiving controller 102 that the identification data 110 was sent by a sensor 106 that was in the configuration mode. Accordingly, the receiving controller 102 may use the identification data 110 to update the sensor configuration 112, for instance if the sensor address 118 indicated by the identification data 110 is not yet in the sensor configuration 112.

In other examples, if the configuration trigger 108 was activated based on receipt of an identification data request 128, the sensor 106 may reduce a transmission power while in the configuration mode, such that the identification data 110 broadcast at block 310 is transmitted over a relatively small sensor range area 202 as shown in FIG. 2B. The reduction of the transmission power used to broadcast the identification data 110 may increase the likelihood that only the controller 102 associated with the same machine 104 as the sensor 106 will receive the identification data 110 broadcast at block 310, and decrease the chances that a controller 102 of a different machine 104 will receive the identification data 110 broadcast at block 310. Accordingly, even if the identification data 110 broadcast at block 310 lacks the configuration indicator 130, the controller 102 of the same machine 104 may use the identification data 110 to update the sensor configuration 112 maintained by the controller 102 if that controller 102 had broadcast the identification data request 128.

When the configuration trigger 108 of the sensor 106 is activated and the sensor 106 switches to the configuration mode at block 308, the sensor 106 may remain in the configuration mode for a period of time, such as 30 seconds or any other longer or shorter period of time. During that period of time, the sensor 106 may broadcast the identification data 110 one or more times at block 310. After the sensor 106 has broadcasted the identification data 110 at block 310 and the period of time associated with the configuration mode expires, the sensor 106 may return to the normal operation mode at block 312. The sensor 106 may accordingly return to block 302 to broadcast sensor data 114 and/or identification data 110 while in the normal operation mode.

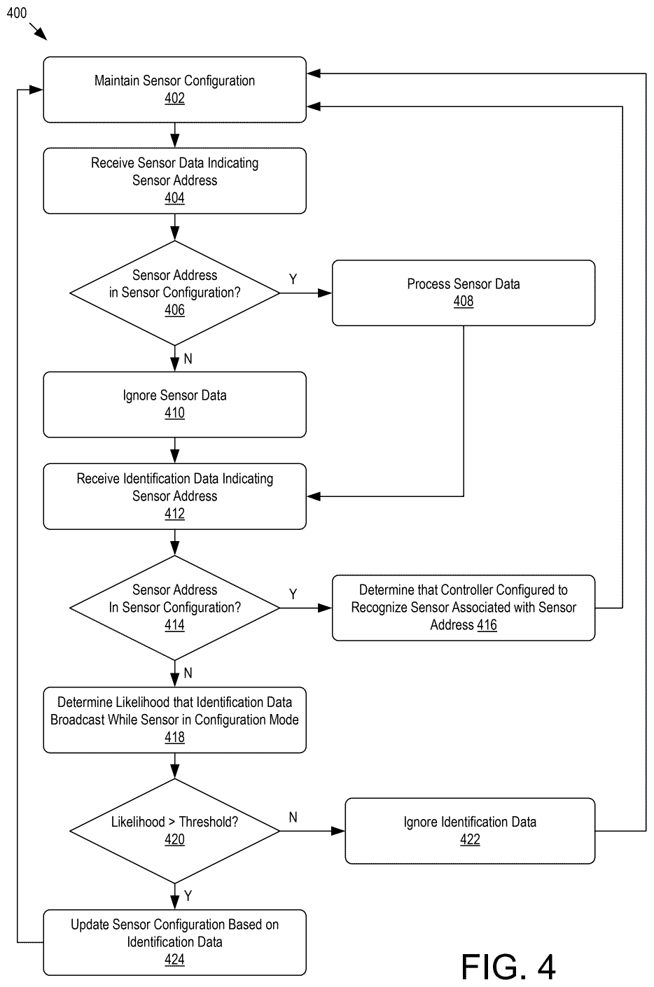

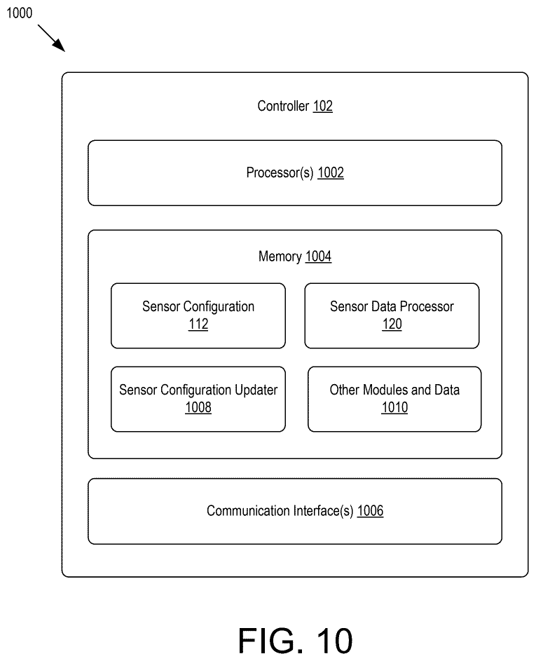

FIG. 4 is a flowchart 400 illustrating an example process a controller 102 of a machine 104 may use to recognize a sensor 106 based on received identification data 110. FIG. 10, discussed further below, describes an example system architecture for such a controller 102.

At block 402, the controller 102 may maintain a sensor configuration 112. The sensor configuration 112 may be a table, database, or other data that indicates sensor addresses 118 of sensors 106 that the controller 102 is currently configured to recognize. The sensor configuration 112 may also indicate sensor attributes 126 of the sensors 106 that correspond to the sensor addresses 118, such as types of the sensors 106, data formats or schemas used by the sensors 106, types of sensor data 114 that the sensors 106 are able to determine and/or transmit, hardware and/or software capabilities of the sensors 106, manufacturers of the sensors 106, mounting locations of the sensors 106 on the machine 104, version numbers of the sensors 106, and/or any other information about the sensors 106.

At block 404, the controller 102 may receive sensor data 114 that indicates a sensor address 118. For example, the sensor data 114 may have been broadcast by a sensor 106 corresponding to the sensor address 118, and the controller 102 may accordingly receive the broadcasted sensor data 114 at block 404.

At block 406, the controller 102 may determine whether the sensor address 118 indicated by the received sensor data 114 is in the sensor configuration 112 maintained by the controller 102. If the sensor address 118 indicated by the received sensor data 114 is in the sensor configuration 112 (Block 406—Yes), the controller 102 may process the received sensor data 114 at block 408. For example, at block 406 the controller 102 may use the sensor configuration 112 to determine sensor attributes 126 associated with the sensor address 118, such as a type of the sensor 106 that sent the sensor data 114, a data format that should be used to interpret the sensor data 114, and/or other information, such that the controller 102 may determine how to process the sensor data 114. In some examples, the controller 102 may process the sensor data 114 by including the sensor data 114 in a report 122 that the controller 102 sends to another system 124, or by using the sensor data 114 to derive or determine information to include in such a report 122.

However, if the sensor address 118 indicated by the received sensor data 114 is not in the sensor configuration 112 (Block 406—No), the controller 102 may ignore the sensor data sensor data 114 at block 410. For example, because the sensor address 118 is not in the sensor configuration 112, the controller 102 may not be currently configured to recognize the sensor 106 identified with the sensor address 118 as being associated with the same machine 104 as the controller 102.

At block 412, the controller 102 may receive identification data 110 that indicates the sensor address 118. For example, the identification data 110 may have been broadcast by the sensor 106 corresponding to the identification data 110, and the controller 102 may accordingly receive the broadcasted identification data 110 at block 412.

At block 414, the controller 102 may determine whether the sensor address 118 indicated by the received identification data 110 is in the sensor configuration 112 maintained by the controller 102. If the sensor address 118 indicated by the received identification data 110 is in the sensor configuration 112 (Block 414—Yes), the controller 102 may determine at block 416 that the controller 102 is already configured to recognize the sensor 106 associated with the sensor address 118. For example, because the sensor address 118 is in the sensor configuration 112, the controller 102 may process corresponding sensor data 114 at block 408, as discussed above. Because the controller 102 is already configured to recognize the sensor 106 associated with the sensor address 118 based on the current sensor configuration 112, the controller 102 may return to block 402 without updating the sensor configuration 112.

However, if the sensor address 118 indicated by the received identification data 110 is not in the sensor configuration 112 (Block 414—No), the controller 102 may at block 418 determine a likelihood that the identification data 110 was broadcast by a sensor 106 while that sensor 106 was in a configuration mode. In some examples, the controller 102 may determine that it is highly likely that the identification data 110 was broadcast by a sensor 106 in a configuration mode if the identification data 110 has a configuration indicator 130. The configuration indicator 130 may be a configuration flag, distinct data format, or other indication that the identification data 110 was broadcast by a sensor 106 in a configuration mode.

In other examples, the controller 102 may determine that it is likely that the identification data 110 was broadcast by a sensor 106 in a configuration mode if the identification data 110 is received within a threshold period of time after the controller 102 itself broadcasted an identification data request 128, and correspondingly lowered a power level to reduce the size of a controller range area 204 used to listen for identification data 110 broadcast by sensors 106 in response to the identification data request 128. For example, if the controller 102 is using a relatively small controller range area 204 as shown in FIG. 2B during a period of time following the broadcast of an identification data request 128, and the identification data 110 is received at block 412 during that period of time, the controller 102 may determine at block 418 that it is likely that a sensor 106 broadcast the identification data 110 while in a configuration mode triggered by the identification data request 128 from the controller 102.

At block 420, the controller 102 may determine whether the likelihood, of the identification data 110 having been broadcast by a sensor 106 that was in a configuration mode, exceeds a threshold likelihood. If the likelihood does not exceed the threshold (Block 420—No), the controller 102 may ignore the identification data 110 at block 422 and return to block 402. For example, if the controller determines that the identification data 110 was unlikely to have been sent by a sensor 106 that was in the configuration mode, for instance because the identification data 110 does not have a configuration indicator 130 or was not received within a threshold time of the controller 102 broadcasting an identification data request 128, the sensor 106 that sent the identification data 110 may have been operating in a normal mode. That sensor 106 may, for instance, be associated with another machine 104 or may otherwise not be associated with the same machine 104 as the controller 102, such that there is no indication that the sensor address 118 indicated by the identification data 110 should be added to the sensor configuration 112 maintained by the controller 102.

If the likelihood, of the identification data 110 having been broadcast by a sensor 106 that was in a configuration mode, instead exceeds the threshold likelihood does not exceed the threshold (Block 420—Yes), the controller 102 may update the sensor configuration 112 based on the identification data 110 at block 424. For example, if the identification data 110 has a configuration indicator 130 or was received within a threshold time of the controller 102 broadcasting an identification data request 128, the sensor 106 that sent the identification data 110 may have been operating in the configuration mode in response to activation of a configuration trigger 108. The controller 102 may accordingly determine that the sensor 106 is likely to be associated with the same machine 104 as the controller 102. The controller 102 may configure itself to recognize the sensor 106 by adding the sensor address 118 indicated by the identification data 110 to the sensor configuration 112. The controller 102 may also pair the sensor address 118 in the sensor configuration 112 with sensor attributes 126 that are indicated by the identification data 110 and/or are derived from the identification data 110.

After updating the sensor configuration 112 at block 424 to include the sensor address 118 and/or sensor attributes 126 indicated by the identification data 110 at block 424, the controller 102 may return to block 402. Accordingly, if the controller 102 later receives sensor data 114 that indicates the sensor address 118 added to the sensor configuration 112, the controller 102 may determine that the sensor data 114 is associated with a sensor 106 that the controller 102 has been configured to recognize, and may process that sensor data 114 at block 408. Similarly, if the controller 102 later receives identification data 110 that indicates the sensor address 118 added to the sensor configuration 112, the controller 102 may determine at block 416 that the controller 102 has been configured to recognize the sensor 106 associated with the sensor address 118.

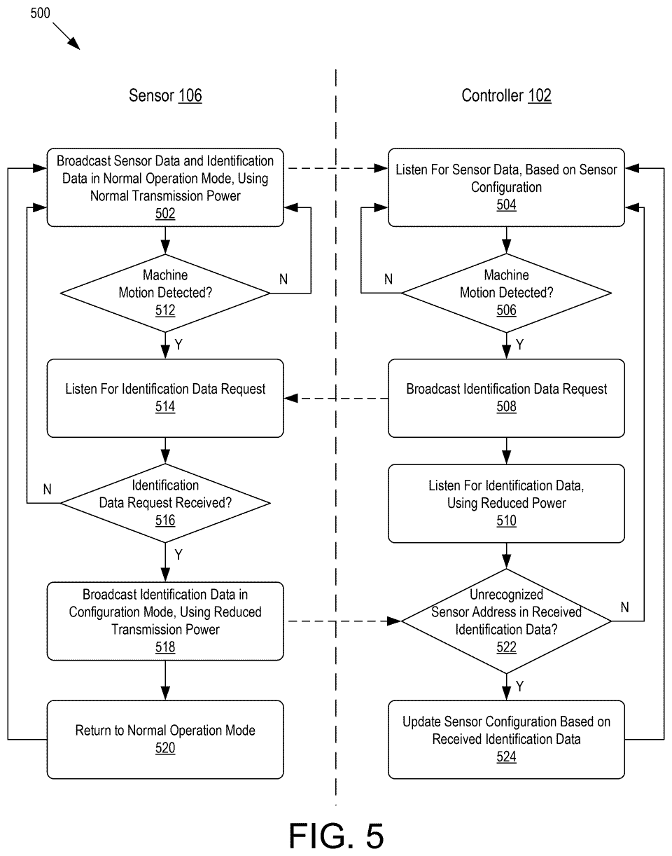

FIG. 5 is a flowchart 500 illustrating an example process by which a controller 102 of a machine 104 may be configured to recognize a sensor 106 associated with the machine 104. FIG. 9, discussed further below, describes an example system architecture for such a sensor 106. FIG. 10, discussed further below, describes an example system architecture for such a controller 102.

At block 502, the sensor 106 may broadcast sensor data 114 and/or identification data 110 while the sensor 106 is in a normal operation mode, for example as discussed above with respect to block 302 of FIG. 3. The sensor 106 may broadcast the sensor data 114 and/or identification data 110, in the normal operating mode, using normal transmission power, such that the sensor range area 202 associated with such broadcasts is relatively large as shown in FIG. 2A.

At block 504, the controller 102 may listen for sensor data 114 that has been broadcast by sensors 106, such as the sensor data 114 broadcast by the sensor 106 at block 502. If the controller 102 receives such sensor data 114, and the sensor data 114 indicates a sensor address 118 that is in sensor configuration 112 maintained by the controller, the controller 102 may process the sensor data 114, for example as discussed above with respect to block 408 of FIG. 4.

At block 506, the controller 102 may use accelerometer data, speed data, and/or other information associated with movement of the machine 104 to determine whether the machine 104 is in motion and/or is traveling at a speed that meets or exceeds a threshold speed. If the controller 102 does not detect such motion of the machine 104 (Block 506—No), the controller 102 may continue listening for sensor data sensor data 114 at block 504. However, if the controller 102 does detect sufficient motion of the machine 104 (Block 506—Yes), the controller 102 may broadcast an identification data request 128 at block 508. For example, the controller 102 may use the motion of the machine 104 as a trigger to broadcast an identification data request 128 in order to prompt any or all sensors 106 currently on the machine 104 to switch to configuration modes and broadcast corresponding identification data 110 that the controller 102 may use to update the sensor configuration 112 maintained by the controller 102.

When the controller 102 broadcasts the identification data request 128 at block 508, the controller 102 may at block 510 also begin listing for identification data 110 that sensors 106 may broadcast in response to the identification data request 128. The controller 102 may use a reduced power level to listen for identification data 110 after broadcasting the identification data request 128, such that the size of a controller range area 204 is reduced as shown in FIG. 2B. Accordingly, using the reduced power level to listen for identification data 110 may increase the likelihood of the controller 102 only receiving identification data 110 from sensors 106 that are currently on the same machine 104 as the controller 102, and reduce the chances of identification data 110 being received from other sensors 106, such as sensors 106 on other machines 104. In some examples, the controller 102 may also use reduce the power level used to transmit the identification data request 128 at block 508, to increase the chances that only sensors 106 that are currently on the machine 104 and that are within the smaller controller range area 204 may receive and respond to the identification data request 128. The controller 102 may be configured to use the lower power level to listen for identification data 110 at block 510 for a defined period of time following the broadcast of the identification data request 128 at block 508, such as 30 seconds or any longer or shorter period of time.

In some examples, the sensor 106 may also be configured to detect motion of the machine 104. For instance, the sensor 106 may be configured to use accelerometer data or other data to detect motion of the sensor 106 itself, which may indicate that the machine 104 associated with the sensor 106 is also in motion. Because motion of the machine 104 may trigger the controller 102 to broadcast an identification data request 128 at block 508, the sensor 106 may also be configured to listen for such an identification data request 128 in response to detection of motion of the machine 104. Accordingly, the sensor 106 may determine at block 512 whether the sensor 106 detects motion of the machine 104. If the sensor 106 does not detect motion of the machine 104 (Block 512—No), the sensor 106 may continue broadcasting sensor data 114 and/or identification data 110 in a normal configuration mode at block 502. However, if the sensor 106 detect motion of the machine 104 (Block 512—Yes), the sensor 106 may at block 514 begin actively listening for an identification data request 128 broadcast by a controller 102. In other examples, the sensor 106 may be configured to actively listen for an identification data request 128 at other times and/or in other conditions at block 514, without prior detection of motion of the machine 104.

At block 516, the sensor 106 may determine whether an identification data request 128 has been received. If the sensor 106 has not received an identification data request 128 (Block 516—No), the sensor 106 may continue broadcasting sensor data 114 and/or identification data 110 in a normal configuration mode at block 502. However, if the sensor 106 has received an identification data request 128 (Block 516—Yes), the sensor 106 may at block 518 switch to the configuration mode and broadcast identification data 110 that indicates the sensor address 118 and/or sensor attributes 126 of the sensor 106. Because the sensor 106 broadcasts the identification data 110 at block 518 in response to the identification data request 128 sent by the controller 102, the sensor 106 may use a reduced transmission power level to broadcast the identification data 110 while in the configuration mode. Using such a reduced transmission power level at block 518 may decrease the size of the sensor range area 202 as shown in FIG. 2B while the sensor 106 is in the configuration mode, relative to a larger size of the sensor range area 202 used in the normal configuration mode at block 502 and as shown in in FIG. 2A. Accordingly, the decrease in the size of the sensor range area 202 used to broadcast the identification data 110 at block 518 in response to the identification data request 128 sent by the controller 102 may increase the chances that only the controller 102 on the same machine 104 as the sensor 106 will receive the identification data 110, and decrease the chances that controllers of other machines will receive the identification data 110 broadcast at block 518.

The sensor 106 may remain in the configuration mode for period of time following receipt of the identification data request 128, such as 30 seconds or any other longer or shorter period of time, and may broadcast the identification data 110 one or more times during that period of time. After the sensor 106 has broadcast the identification data 110 at block 518 and the period of time associated with the configuration mode has expired, the sensor 106 may return to the normal operation mode at block 520. The sensor may accordingly return to block 502 to continue broadcasting sensor data 114 and/or identification data 110 in the normal configuration mode.

As noted above, at block 510 the controller 102 may have begun listening for identification data 110 broadcast by sensors 106 in response to the identification data request 128 broadcast by the controller 102 at block 508. The controller 102 may be configured to use a low power level to listen for identification data 110 at block 510 for a defined period of time following the broadcast of the identification data request 128 at block 508, such as 30 seconds or any longer or shorter period of time. Accordingly, the controller 102 may determine whether identification data 110 has been received during the period of time following the broadcast of the identification data request 128 at block 508. The controller 102 may also, at block 522, determine whether any received identification data 110 received during that period of time indicates an unrecognized sensor address 118 that is not currently in the sensor configuration 112 maintained by the controller 102.

If identification data 110 received by the controller 102 in response to the identification data request 128 does not indicate any sensor addresses 118 that are not already in the sensor configuration 112 (Block 522—No), the controller 102 may already be configured to recognize the sensors 106 that are currently on the machine 104 and that responded to the identification data request 128 by broadcasting identification data 110. Accordingly, the controller 102 may return to block 504 to continue listing for sensor data 114 from those sensors 106.

However, if identification data 110 received by the controller 102 in response to the identification data request 128 does indicate an unrecognized sensor address 118 that is not already in the sensor configuration 112 (Block 522—Yes), the controller 102 may update the sensor configuration 112 based on that identification data 110 at block 524. Because the controller 102 reduced the power level used to listen for identification data 110 at block 510, the controller 102 may determine with a high level of confidence that the identification data 110 indicating the unrecognized sensor address 118 is present within a smaller controller range area 204 that encompasses the machine 104 but does not encompass other machines, and that the sensor 106 that broadcast the identification data 110 is therefore likely to be on the same machine 104 as the controller 102. The controller 102 may update the sensor configuration 112 based on the identification data 110 by adding the sensor address 118 indicated by the identification data 110, and/or by adding sensor attributes 126 that are indicated by the identification data 110 and/or are derived from the identification data 110, for example as discussed above with respect to block 424 of FIG. 4. After updating the sensor configuration 112 at block 524, the controller 102 may return to block 504 to continue listing for sensor data 114. If later-received sensor data 114 indicates the sensor address 118 added to the sensor configuration 112 at block 524, the controller 102 may determine that the sensor data 114 is from a sensor 106 that is currently on the machine 104 and that the controller 102 has been configured to recognize, such that the controller 102 may accordingly process the sensor data 114.

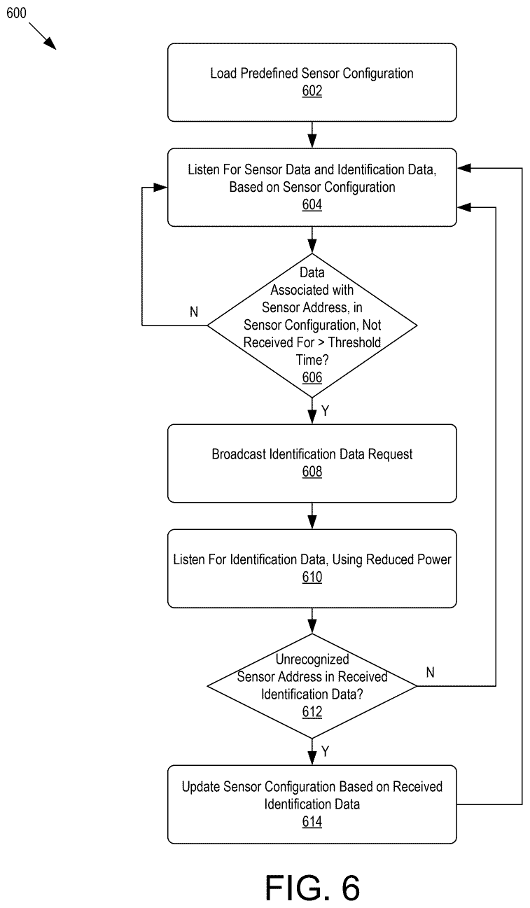

FIG. 6 is a flowchart 600 illustrating an example process a controller 102 of a machine 104 may use to detect a dormant sensor 106 or a replacement sensor 106 based on received identification data 110. FIG. 10, discussed further below, describes an example system architecture for such a controller 102.

At block 602, the controller 102 may load a predefined sensor configuration 112. The predefined sensor configuration 112 may be based on a new sensor configuration 112 provided to the controller 102 at a factory, based on previous updates to the sensor configuration 112 made manually via a computer or other device used by a technician, or another previously-existing state of the sensor configuration 112. For example, if a technician installs a sensor 106 on the machine 104 at a factory or maintenance facility, the technician may use a computer or other device to manually update the sensor configuration 112 of the controller 102 to include a sensor address 118 of that sensor 106.

Accordingly, at block 604, the controller 102 may use the predefined sensor configuration 112 to listen for sensor data 114 and/or identification data 110 that indicates sensor addresses 118 in the sensor configuration 112. For example, if the controller 102 receives sensor data 114 that indicates a sensor address 118 that is in the sensor configuration 112, the controller 102 may process the sensor data 114, for example as discussed above with respect to block 408 of FIG. 4.

The controller 102 may also track when instances of sensor data 114 and/or identification data 110 that indicate sensor addresses 118 in the sensor configuration 112 are received by the controller 102. Accordingly, at block 606 the controller 102 may determine whether sensor data 114 and/or identification data 110 indicating a sensor address 118 in the sensor configuration 112 has not been received for at least a threshold period of time, such as 40 machine operating hours or any other longer or shorter period of time.

If the controller 102 determines that the threshold period of time has not elapsed between receipt of instances of sensor data 114 and/or identification data 110 indicating all of the sensor address 118 in the sensor configuration 112 (block 606—No), the controller 102 may continue to listen for such sensor data 114 and/or identification data 110 at block 604. However, if sensor data 114 or identification data 110 indicating one of the sensor address 118 in the sensor configuration 112 has not been received for at least a threshold period of time (block 606—Yes), there may be a chance that the corresponding sensor 106 has been replaced such that the current sensor configuration 112 being used by the controller 102 is out of date. Accordingly, at block 606 the controller 102 may broadcast an identification data request 128 to prompt a replacement sensor 106, if present on the machine 104, to switch to a configuration mode and broadcast corresponding identification data 110. If the original sensor 106 is still present on the machine 104, but had gone dormant such that it had not broadcasted identification data 110 for at least the threshold period of time, the identification data request 128 broadcast at block 608 may prompt the original sensor 106 to broadcast such identification data 110 so that the controller 102 may confirm that the original sensor 106 is still present on the machine 104.

When the controller 102 broadcasts the identification data request 128 at block 608, the controller 102 may at block 610 also begin listing for identification data 110 that sensors 106 may broadcast in response to the identification data request 128. The controller 102 may use a reduced power level to listen for identification data 110 after broadcasting the identification data request 128, such that the size of a controller range area 204 is reduced as shown in FIG. 2B. Accordingly, using the reduced power level to listen for identification data 110 may increase the likelihood of the controller 102 only receiving identification data 110 from sensors 106 that are currently on the same machine 104 as the controller 102, and reduce the chances of identification data 110 being received from other sensors 106, such as sensors 106 on other machines 104. In some examples, the controller 102 may also use reduce the power level used to transmit the identification data request 128 at block 608, to increase the chances that only sensors 106 that are currently on the machine 104 and that are within the smaller controller range area 204 may receive and respond to the identification data request 128. The controller 102 may be configured to use the lower power level to listen for identification data 110 at block 610 for a defined period of time following the broadcast of the identification data request 128 at block 608, such as 30 seconds or any longer or shorter period of time.

The controller 102 may determine whether identification data 110 is received during the period of time following the broadcast of the identification data request 128 at block 610. At block 612, the controller 102 may determine whether any received identification data 110 received during that period of time indicates an unrecognized sensor address 118 that is not currently in the sensor configuration 112 maintained by the controller 102.

If identification data 110 received by the controller 102 in response to the identification data request 128 does not indicate any sensor addresses 118 that are not already in the sensor configuration 112 (Block 612—No), the controller 102 may already be configured to recognize the sensors 106 that are currently on the machine 104 and that responded to the identification data request 128 by broadcasting identification data 110. Accordingly, the controller 102 may return to block 604 to continue listening for sensor data 114 and/or identification data 110 based on the current sensor configuration 112 maintained by the controller 102.

As an example, the sensor 106 that was determined at block 606 to not have sent sensor data 114 and/or identification data 110 for at least the threshold period of time may have been dormant, but may have broadcast identification data 110 in response to the identification data request 128 broadcast by the controller 102 at block 608. As an example, the sensor 106 that was determined at block 606 to not have sent sensor data 114 and/or identification data 110 for at least the threshold period of time may have been removed from the machine 104 and not been replaced, such that a replacement sensor 106 did not broadcast identification data 110 in response to the identification data request 128 broadcast by the controller 102 at block 608.

However, if identification data 110 received by the controller 102 in response to the identification data request 128 does indicate an unrecognized sensor address 118 that is not already in the sensor configuration 112 (Block 612—Yes), the controller 102 may update the sensor configuration 112 based on that identification data 110 at block 614. Because the controller 102 reduced the power level used to listen for identification data 110 at block 610, the controller 102 may determine with a high level of confidence that the identification data 110 indicating the unrecognized sensor address 118 is present within a smaller controller range area 204 that encompasses the machine 104 but does not encompass other machines, and that the sensor 106 that broadcast the identification data 110 is therefore likely to be on the same machine 104 as the controller 102. The controller 102 may update the sensor configuration 112 based on the identification data 110 by adding the sensor address 118 indicated by the identification data 110, and/or by adding sensor attributes 126 that are indicated by the identification data 110 and/or are derived from the identification data 110, for example as discussed above with respect to block 424 of FIG. 4.

For example, if the sensor 106 that was determined at block 606 to not have sent sensor data 114 and/or identification data 110 for at least the threshold period of time has been replaced with a new sensor 106 on the machine 104, the newly-received identification data 110 with the unrecognized sensor address 118 may be from the replacement sensor 106. Accordingly, the controller 102 may add the sensor address 118 indicated by the newly-received identification data 110, and/or corresponding sensor attributes 126, to the sensor configuration 112 maintained by the controller 102.

After updating the sensor configuration 112 at block 614, the controller 102 may return to block 604 to continue listening for sensor data 114 and/or identification data 110 based on the updated sensor configuration 112. For example, if later-received sensor data 114 indicates the sensor address 118 added to the sensor configuration 112 at block 614, the controller 102 may determine that the sensor data 114 is from a sensor 106 that is currently on the machine 104 and that the controller 102 has been configured to recognize, such that the controller 102 may accordingly process the sensor data 114.

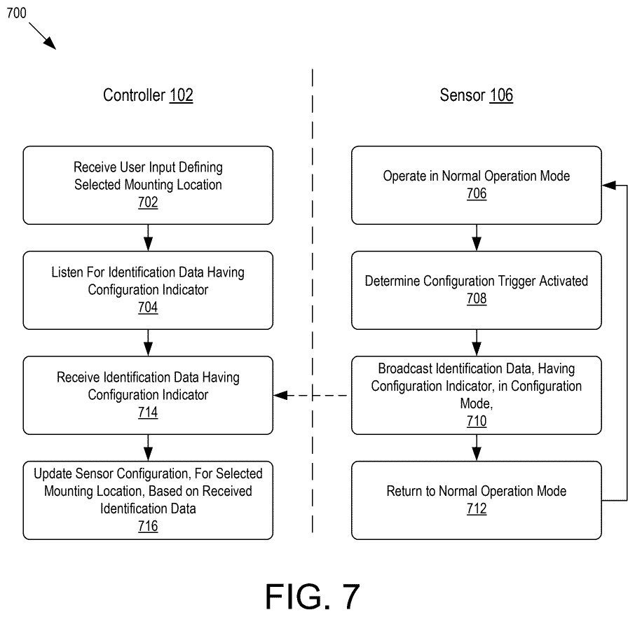

FIG. 7 is a flowchart 700 illustrating an example process by which a controller 102 of a machine 104 may be configured to recognize a sensor 106 associated with the machine 104 and a mounting location of the sensor 106 on the machine 104. FIG. 9, discussed further below, describes an example system architecture for such a sensor 106. FIG. 10, discussed further below, describes an example system architecture for such a controller 102.

At block 702, the controller 102 may receive user input that defines a selected mounting location for a sensor 106 that is being configured. For example, the controller 102 may interface with a screen or other display in a cab of the machine 104, which may display a user interface, input controls, and/or other elements that allows a user to provide input selecting a mounting location. As another example, a technician or other user may connect a laptop computer, service tool, or other device to the controller 102 via a wired or wireless connection, such that the user can use the device to provide input selecting a mounting location. The user input received at block 702 may also define a selected sensor type and/or other information about the sensor 106.

The mounting location selected via the user input received at block 702 may indicate a location, on the machine 104, of the sensor 106 that is being configured. For example, if a technician is installing a sensor 106 that could be installed at multiple locations on the machine 104, such as at a front end of the machine 104, at a back end of the machine 104, on a left side of the machine 104, or on a right side of the machine 104, the technician may provide user input at block 702 to indicate one of those potential locations at which the sensor 106 has been installed or will be installed.

At block 704, the controller 102 may listen for identification data 110, broadcast by a sensor 106, that includes a configuration indicator 130. The selection of the mounting location at block 702 can cause the controller 102 to listen for identification data 110 that includes a configuration indicator 130 for at least a threshold period of time, such as 30 seconds or any longer or shorter period of time.

The user that provided the user input received by the controller 102 at block 702, or a different user, may activate the configuration trigger 108 of the sensor 106 while the controller 102 is listening for identification data 110 at block 704. In some examples, after user input defining the mounting location of a sensor 106 has been provided to the controller 102, a user may activate a physical configuration trigger 108 of the sensor 106 by pressing a button on the sensor 106, touching a touch pad of the sensor 106, tapping or moving the sensor 106 to cause an accelerometer of the sensor 106 to detect activation of the configuration trigger 108, moving a magnetic component near the sensor 106, and/or via other manual actions. In other examples, after user input defining the mounting location of a sensor 106 has been provided to the controller 102, a user may activate a digital configuration trigger 108 of the sensor 106 by using a settings tool or other computing device, different from the controller 102, to transmit a signal or other data via a wired or wireless data connection that activates the digital configuration trigger 108 of the sensor 106.

Accordingly, although the sensor 106 may initially operate in a normal operation mode at block 706, the sensor 106 may determine at block 708 that the configuration trigger 108 of the sensor 106 has been activated based on manual user input or data received from a user device. Accordingly, activation of the configuration trigger 108 of the sensor 106 at block 708 may cause the sensor 106 to, at block 710, switch to the configuration mode and broadcast identification data 110 that has the configuration indicator 130. The identification data 110 broadcast at block 710 may indicate the sensor address 118 of the sensor 106. The identification data 110 broadcast at block 710 may also indicate some types of sensor attributes 126, but may omit a mounting location of the sensor 106 because the sensor 106 itself may not have been configured with information indicating where the sensor 106 has, or will be, installed on the machine 104. After broadcasting the identification data 110 at block 710, at block 712 the sensor 106 may return to the normal operation mode and operate in the normal operation mode at block 706 until the next time a configuration trigger 108 of the sensor 106 is activated.

At block 714, the controller 102 may receive the identification data 110, having the configuration indicator 130, broadcast by the sensor 106 at block 710. The controller 102 may receive the identification data 110 during a period of time in which the controller 102 is listening for such identification data 110 at block 704, in response to receipt of user input indicating the selected mounting location at block 702. The user input, received at block 702, may cause the controller 102 to consider the next identification data 110 having the configuration indicator 130 that is received by the controller 102 to be from a sensor 106 that is at the mounting location indicated by the user input. Accordingly, when the controller 102 receives the identification data 110 at block 714, the controller 102 can determine that the identification data 110 was broadcast by a sensor that is at the selected mounting location defined by the user input.

At block 716, the controller 102 may accordingly update the sensor configuration 112 maintained by the controller 102 based on the identification data 110 received at block 714. For example, if the user input received at block 702 indicated that a sensor 106 on the left side of the machine 104 is being configured, at block 716 the controller 102 may add an entry to the sensor configuration 112 indicating that a sensor 106 associated with the sensor address 118 indicated by the identification data 110 is present on the left side of the machine 104. In some examples, sensor attributes 126 expressed in the identification data 110 may also indicate a sensor type or other data, such that the controller 102 may indicate that information in the entry added to the sensor configuration 112. In other examples, if the user input received at block 702 indicated a sensor type or other data to be associated with the sensor 106 being configured, the controller 102 may indicate that information in the entry added to the sensor configuration 112.

After the sensor configuration 112 is updated at block 716, the controller 102 may now be configured to recognize and process sensor data 114 received from the sensor 106 in the future. For instance, because the sensor configuration 112 may now indicate the sensor address 118 of the sensor 106 and the mounting location of that sensor 106 on the machine 104, the controller 102 may determine that future sensor data 114 indicating that sensor address 118 is associated with a sensor 106 positioned at the corresponding mounting location identified in the sensor configuration 112. The controller 102, may for example, distinguish that sensor data 114 from similar sensor data 114 received from other instances of the same type of sensor that are present at other mounting locations on the machine 104.

The process shown in FIG. 7 may be repeated for sensors at other mounting locations. For example, the process shown in FIG. 7 may be used at a first time to configure the controller 102 with a first sensor address 118 of a first sensor mounted on a left side of the machine 104, based on first user input at block 702 that selects the left side of the machine 104. The process shown in FIG. 7 may later be repeated at a second time to configure the controller 102 with a second sensor address 118 of a second sensor mounted on a right side of the machine 104, based on second user input at block 702 that selects the right side of the machine 104.

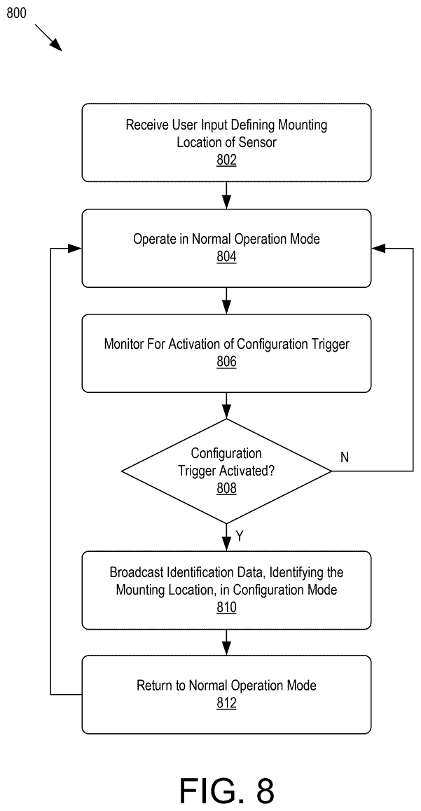

FIG. 8 is a flowchart 800 illustrating an example process in which a sensor 106 may be configured with a mounting location, and may indicate the mounting location in identification data 110 broadcast while the sensor 106 is in a configuration mode. FIG. 9, discussed further below, describes an example system architecture for such a sensor 106.

At block 802, the sensor 106 may receive user input that defines a mounting location of the sensor 106. The mounting location may be a location on the machine 104 at which the sensor 106 is, or will be, installed. For example, the sensor 106 may be a type of sensor that could be installed at a set of predefined locations on the machine 104, such as on the left side or right side of the machine 104 or a component of the machine 104. Accordingly, the user input may indicate a particular mounting location selected from among the set of predefined locations at which the sensor 106 could be installed.

A technician or other user may provide the user input received at block 804 may manually interacting with the sensor 106, or by indirectly interacting with the sensor 106 via a settings tool, computer, or other device different from the controller 102 of the machine 104. For example, if the sensor 106 could be mounted on the left side or the right side of the machine 104, a technician may use one or more controls on the sensor 106, such as a toggle switch, a button, a touch sensor, or other control, to indicate whether the sensor 106 is actually mounted on, or will be mounted on, the left side or the right side of the machine 104. For instance, the technician may press a button on the sensor 106 one time to indicate that the sensor 106 is mounted on the left side of the machine 104, or press the button on the sensor 106 two times to indicate that the sensor 106 is mounted on the right side of the machine 104. The sensor 106 may have memory that stores the mounting location data configured by the technician via the controls of the sensor 106. As another example, a technician may use a service tool, mobile computing device, laptop computer, or other device that interfaces with the sensor 106 to provide user input identifying the mounting location of the sensor 106, such that the sensor 106 may store corresponding mounting location data in memory of the sensor 106.

At block 804, after the sensor 106 has received user input defining the mounting location of the sensor 106, the sensor may operate in the normal operation mode. For example, the sensor 106 may broadcast sensor data 114 and/or identification data 110 while operating in the normal operating mode. The identification data 110 may indicate the identification data request 128 and sensor attributes 126 such as the mounting location of the sensor 106. However, because the sensor 106 is in the normal operating mode, the identification data 110 broadcast at block 804 may omit a configuration indicator 130.

At block 806, the sensor 106 may monitor for activation of a configuration trigger 108 of the sensor 106. As an example, the configuration trigger 108 of the sensor 106 may be a physical control, such as a button, a touch sensor, an accelerometer, a magnetic component, or other type of control that a user may selectively activate manually and/or via a magnetic device or other activation tool. As another example, the configuration trigger 108 may be a digital trigger that is activated via a wireless or wired signal from a service tool or other user device, or via an identification data request 128 broadcast by a controller 102 of a machine 104.

At block 808, the sensor 106 may determine whether the configuration trigger 108 has been activated. If the configuration trigger 108 has not been activated (Block 808—No), the sensor 106 may remain in the normal operation mode and return to block 804 to broadcast sensor data 114 and/or identification data 110. However, if the sensor 106 determines that the configuration trigger 108 has been activated (Block 808—Yes), the sensor 106 may switch to the configuration mode and broadcast identification data 110 at block 810.

The identification data 110 that the sensor 106 broadcasts while in the configuration mode at block 810 may include the sensor address 118 of the sensor 106, and may also indicate the mounting location of the sensor 106. For example, because data indicating the mounting location of the sensor 106 may be stored in memory of the sensor 106 based on the user input received at block 802, the sensor 106 may include that mounting location data in the identification data 110 broadcast at block 810, or otherwise indicate the mounting location of the sensor 106 in the identification data 110 broadcast at block 810. The identification data 110 broadcast at block 810 may also indicate other sensor attributes 126 of the sensor 106.

In some examples, the identification data 110 broadcast at block 810 while the sensor 106 is in the configuration mode may have the configuration indicator 130, to signify to a receiving controller 102 that the identification data 110 was sent by a sensor 106 that was in the configuration mode. In other example, if the configuration trigger 108 was activated based on receipt of an identification data request 128, the sensor 106 may reduce a transmission power while in the configuration mode, such that the identification data 110 broadcast at block 810 is transmitted over a relatively small sensor range area 202 as shown in FIG. 2B in order to increase chances that only the controller 102 associated with the same machine 104 as the sensor 106 will receive the identification data 110.

After the sensor 106 has broadcasted the identification data 110 at block 810, for example at one or more times during a period of time associated with the configuration mode, the sensor 106 may return to the normal operation mode at block 812. The sensor 106 may accordingly return to block 804 to broadcast sensor data 114 and/or identification data 110 while in the normal operation mode.

The controller 102 of the machine 104 may receive the identification data 110 broadcast by the sensor 106 at block 810, and may use the identification data 110 to update the sensor configuration 112 maintained by the controller 102. For example, if the identification data 110 includes the sensor address 118 of the sensor 106 and indicates that the sensor 106 is mounted at a front end of the machine 104, the controller 102 may add an entry to the sensor configuration 112 indicating that the sensor 106 associated with the sensor address 118 is located at the front end of the machine 104. In some examples, sensor attributes 126 expressed in the identification data 110 may also indicate a sensor type or other data, such that the controller 102 may indicate that information in the entry added to the sensor configuration 112.

The process shown in FIG. 8 may be performed at different times for different sensors 106 associated with different mounting locations. For example, the process shown in FIG. 8 may be used at a first time to configure a first sensor with mounting data identifying a first mounting location, and to cause the first sensor to broadcast first identification data 110 indicating a first sensor address 118 and the first mounting location. Accordingly, a controller 102 may update sensor configuration 112 maintained by the controller 102 based on the first identification data 110 to associate the first sensor address 118 with the first mounting location indicated by the first identification data 110. Similarly, the process shown in FIG. 8 may be used at a second time to configure a second sensor with mounting data identifying a second mounting location, and to cause the second sensor to broadcast second identification data 110 indicating a second sensor address 118 and the second mounting location. Accordingly, a controller 102 may update sensor configuration 112 maintained by the controller 102 based on the second identification data 110 to associate the second sensor address 118 with the second mounting location indicated by the second identification data 110.

FIG. 9 shows an example system architecture 900 for a sensor 106 that executes one or more elements described in the present disclosure. As discussed above, the sensor 106 may be a type of sensor that is associated with a machine 104, such as a sensor that may be temporarily or permanently mounted to the machine 104, or a sensor that may be transported onto and/or by the machine 104. For example, the sensor 106 may be a work tool sensor that is configured to measure or determine a position and/or orientation of a work tool of the machine 104, a temperature sensor that is configured to measure a temperature of an engine, drivetrain element, or other component of the machine 104, a fuel level sensor configured to determine a current fuel level of the machine 104, a track wear sensor that measures a depth of a tread on a track of the machine 104, a tire pressure sensor configured to measure pressure of a tire of the machine 104, an oil cap sensor configured to measure an oil level associated with an engine of the machine 104, a wireless key fob compatible with the machine 104, a battery sensor configured to monitor or determine attributes of a battery of the machine 104, and/or any other type of sensor.

The sensor 106 may be a computing device that includes one or more processors 902, memory 904, and/or communication interfaces 906. The sensor 106 may also include other elements, such as one or more sensing elements 908, a hardware configuration trigger 910, and/or a motion sensor 912. The one or more sensing elements 908 may be components that detect a state of the sensor 106, perform measurements associated with the sensor 106 and/or a surrounding environment, and/or that make other determinations. The hardware configuration trigger 910 may be a hardware instance of the configuration trigger 108, such as a button, touch sensor, magnetic sensor, or other type of control element, that a user or user device may physically interact with in order to activate the hardware configuration trigger 910. The motion sensor 912 may be an accelerometer or other motion sensor incorporated into the sensor 106, such that the sensor 106 may detect when the sensor 106, and thus the machine 104, is in motion. In some examples, the motion sensor 912 may be a sensing element 908 of the sensor 106.

The processor(s) 902 of the sensor 106 may operate to perform a variety of functions as set forth herein. The processor(s) 902 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 902 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 902 may also access content and computer-executable instructions stored in the memory 904, and execute such computer-executable instructions.

The memory 904 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 902 to perform the operations described herein.

For example, the memory 904 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 902 and/or communication interface(s) 906 during execution thereof by the sensor 106. For example, the processor(s) 902 may possess local memory, which also may store program modules, program data, and/or one or more operating systems.

The memory 904 may store data and/or computer-executable instructions associated with elements of the sensor 106 described herein. As an example, the memory 904 may store the sensor address 118 of the sensor 106, such as a unique MAC address of the sensor 106. As another example, the memory 904 may store sensor mounting location data 914 indicating a mounting location of the sensor 106 on the machine 104, if the sensor 106 has been configured to store such sensor mounting location data 914. The memory 904 may also, or alternately, store data indicating one or more other sensor attributes 126, such as a type of the sensor 106, a data format or schema used by the sensor 106, a type of sensor data 114 that the sensor 106 broadcasts, hardware and/or software capabilities of the sensor 106, a manufacturer of the sensors 106, a version number of the sensor 106, and/or any other information about the sensor 106.

The memory 904 may also store other data and/or computer-executable instructions, such as data and/or computer-executable instructions associated with a sensor data generator 116, a digital configuration trigger 916, and/or a mode controller 918. The sensor data generator 116 may generate sensor data 114 and/or cause the communication interfaces 906 of the sensor 106 to broadcast the sensor data 114, for instance based on input from the one or more sensing elements 908. The digital configuration trigger 916 may be a software-based instance of the configuration trigger 108 that is configured to be activated based on an identification data request 128 from a controller 102 and/or based on an activation signal or other data received via a wired or wireless data connection with a user device or settings tool. The mode controller 918 may switch the sensor 106 from a normal operating mode to a configuration mode, for instance based on activation of the hardware configuration trigger 910 or the digital configuration trigger 916. The mode controller 918 may also return the sensor 106 from the configuration mode to the normal operating mode, for instance after a threshold period of time has elapsed after the hardware configuration trigger 910 or the digital configuration trigger 916 is activated.

The memory 904 may also store other modules and data 920 that may be utilized by the sensor 106 to perform or enable performing any action taken by the sensor 106. For example, the other modules and data 920 may include a platform, operating system, and/or applications, as well as data utilized by the platform, operating system, and/or applications.

The communication interfaces 906 may include transceivers, modems, interfaces, antennas, and/or other components that may transmit and/or receive data over networks or other data connections, that may broadcast data, that may receive data broadcast by other elements, and/or that may otherwise send and/or receive data. The sensor 106 may accordingly use the communication interfaces 906 to broadcast sensor data 114 and/or identification data 110 while the sensor is in the normal operation mode and/or the configuration mode. The sensor 106 may also use the communication interfaces 906 to receive an identification data request 128 broadcast by a controller 102, and/or to receive a signal or other data that activates the digital configuration trigger 916 from a user device or settings tool.

The sensor 106 may, in some examples, vary power levels used by the communication interfaces 906 to broadcast data and/or listen for data, for instance to control the size of a sensor range area 202. For instance, in some examples or situations, the sensor 106 may lower a power level the communication interfaces 906 use to broadcast identification data 110 when the sensor 106 is in the configuration mode, to reduce the size of the sensor range area 202 as shown in FIG. 2B.

FIG. 10 shows an example system architecture 1000 for a controller 102 that executes one or more elements described in the present disclosure. The controller 102 may include one or more computing devices or other computing elements that include one or more processors 1002, memory 1004, and/or communication interfaces 1006.

The controller 102 may be, or may include, an ECM or other on-board computing system of the machine 104. In other examples, the controller 102 may be a separate computing system or device that may communicate with, and/or integrate with, an ECM or other on-board computing system of the machine 104.

In some examples, elements of the controller 102 described herein may be distributed among multiple computing systems or devices that may have a system architecture similar to the system architecture 1000 shown in FIG. 10. For instance, the sensor configuration 112 maintained by the controller 102 may be stored and/or updated by a first computing system of the machine 104, while the sensor data processor 120 may be executed by a second computing system of the machine 104 based on the sensor configuration 112 maintained by the first computing system.

The processor(s) 1002 of the controller 102 may operate to perform a variety of functions as set forth herein. The processor(s) 1002 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 1002 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 1002 may also access content and computer-executable instructions stored in the memory 1004, and execute such computer-executable instructions.

The memory 1004 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 1002 to perform the operations described herein.

For example, the memory 1004 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 1002 and/or communication interface(s) 1006 during execution thereof by the controller 102. For example, the processor(s) 1002 may possess local memory, which also may store program modules, program data, and/or one or more operating systems.

The memory 1004 may store data and/or computer-executable instructions associated with elements of the controller 102 described herein. For example, the memory 1004 may store data and/or computer-executable instructions associated with the sensor configuration 112, the sensor data processor 120, a sensor configuration updater 1008, and/or other elements. The sensor configuration updater 1008 may be configured to determine whether received identification data 110 should be used to update the sensor configuration 112, and if so may make corresponding updates to the sensor configuration 112 based on the received identification data 110.

The memory 1004 may also store other modules and data 1010 that may be utilized by the controller 102 to perform or enable performing any action taken by the controller 102. For example, the other modules and data 1010 may include a platform, operating system, and/or applications, as well as data utilized by the platform, operating system, and/or applications.

The communication interfaces 1006 may include transceivers, modems, interfaces, antennas, and/or other components that may transmit and/or receive data over networks or other data connections, that may broadcast data, that may receive data broadcast by other elements, and/or that may otherwise send and/or receive data. The controller 102 may accordingly use the communication interfaces 1006 to receive sensor data 114 and/or identification data 110 that has been broadcast by sensors 106. The controller 102 may also use the communication interfaces 906 to broadcast identification data requests 128, to send received sensor data 114 and/or corresponding reports 122 to other systems 124, and/or send or receive any other data.

The controller 102 may, in some examples, vary power levels used by the communication interfaces 1006 to broadcast data and/or listen for data, for instance to control the size of a controller range area 204. For instance, in some examples or situations, the controller 102 may lower a power level the communication interfaces 1006 use to listen for identification data 110 in response to an identification data request 128 broadcast by the sensor 106, to reduce the size of the controller range area 204 as shown in FIG. 2B.

### INDUSTRIAL APPLICABILITY

As described herein, activation of a configuration trigger 108 of a sensor 106 may cause the sensor 106 to enter a configuration mode and broadcast identification data 110 that indicates a sensor address 118 of the sensor 106. A controller 102 of a machine 104 may use the sensor address 118, included in the identification data 110 broadcast by the sensor 106, to update a sensor configuration 112 in order to configure the controller 102 to recognize the sensor 106 as being associated with the machine 104.

Accordingly, the controller 102 may automatically update the sensor configuration 112 to include the sensor address 118 indicated by identification data 110 broadcast by the sensor 106, instead of the sensor configuration 112 being manually updated by a technician or other user. Automatic updating of the sensor configuration 112 maintained by the controller 102, as described herein, may be more accurate than manual updates.

For example, the sensor address 118 of a sensor 106 may be a MAC address, such as a series of hexadecimal characters. In some cases, the MAC address may be printed on a tag or label affixed to the sensor 106, or be provided in a user manual or other documentation provided with the sensor 106. When a technician or other user installs the sensor 106 on a machine 104, the user may attempt to update the sensor configuration 112 associated with a controller 102 of the machine 104 by reading the MAC address on a tag, label, or other documentation associated with the sensor 106, and by manually typing that MAC address into a user interface associated with the controller 102. However, although the MAC address may uniquely identify the sensor 106, the hexadecimal characters of the MAC address may appear to be essentially random to the user. Accordingly, there may be a significant risk of the user making a typographical error when transcribing the MAC address and manually typing the hexadecimal characters of the sensor's MAC address into a user interface associated with the controller 102. Such a typographical error may cause the sensor address 118 added to the sensor configuration 112 to be inaccurate, and thereby cause the controller 102 to not recognize the sensor 106 as being associated with the machine 104.

However, as described herein, a controller 102 may automatically update a sensor configuration 112 based on a MAC address or other sensor address 118 directly indicated by identification data 110 broadcast by a sensor 106. Accordingly, the controller 102 may accurately and automatically update the sensor configuration 112 to indicate the correct MAC address or other sensor address 118 of the sensor 106, without the risk of typographical errors or other user errors.

Automatic updating of the sensor configuration 112 maintained by the controller 102, as described herein, may also be used in situations in which manual updates to the sensor configuration 112 may be difficult or impossible. As an example, as noted above, in some cases a MAC address of a sensor 106 may be printed on a tag, label, or other documentation. However, in some situations such a printed MAC address may become faded and hard to read over time, may be scratched off or become damaged over time, or may experience other issues that may make the printed MAC address difficult or impossible to read such that a user may be unable to manually enter the sensor's MAC address into a user interface associated with the controller 102. In such a situation in which a sensor's MAC address may not be known to a user, the controller 102 may nevertheless automatically update a sensor configuration 112 based on the MAC address directly indicated by identification data 110 broadcast by the sensor 106.

As another example, the controller 102 of a machine 104 may be configured as described herein to broadcast an identification data request 128 in response to detection of motion of the machine 104, for instance when the machine 104 begins moving or moves at a speed that exceeds a threshold speed. When the controller 102 broadcasts the identification data request 128 while the machine 104 is in motion, any or all or the sensors 106 that are currently on the machine 104 and are moving with the machine 104 may be triggered to broadcast identification data 110 indicating the respective sensor addresses 118 of those sensors 106. Accordingly, the controller 102 may automatically update its sensor configuration 112 based on the sensor addresses 118 received in identification data 110 in response to the identification data request 128, to ensure that the controller 102 is configured to recognize any or all of the sensors 106 that are currently on the machine 104.

For instance, a technician or other user may have installed a new sensor 106, such as a new type of sensor 106 or a replacement sensor 106, on the machine 104 while the machine 104 was parked. However, the user may have forgotten to manually update the sensor configuration 112, been unable to manually update the sensor configuration 112, or had made a typographical error when attempting to manually update the sensor configuration 112. Although the controller 102 may thus have an inaccurate or incomplete sensor configuration 112 that does not accurately indicate the MAC address of the new sensor 106 when the machine 104 begins moving, the identification data request 128 broadcast by the controller 102 in response to the motion of the machine 104 may prompt the new sensor 106 to broadcast identification data 110 indicting the MAC address of the new sensor 106. The controller 102 may thus automatically update the sensor configuration 112 to indicate the MAC address of the new sensor 106 that is now on the machine 104 after the machine 104 begins moving.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A method comprising:
receiving, by a controller of a machine, identification data indicating a sensor address of a sensor;
determining, by the controller, that the sensor was likely in a configuration mode at a time at which the sensor broadcast the identification data, based on activation of a configuration trigger of the sensor; and
adding, by the controller, and based on determining that the sensor was likely in the configuration mode, an entry to a sensor configuration maintained by the controller,
wherein the entry includes the sensor address indicated by the identification data, and causes the controller to process subsequent sensor data indicating the sensor address.

2. The method of claim 1, further comprising:
broadcasting, by the controller, an identification data request configured to activate the configuration trigger of the sensor,
wherein the controller determines that the sensor was likely in the configuration mode, based on the time at which the sensor broadcast the identification data being within a threshold period of time following broadcasting of the identification data request by the controller.

3. The method of claim 2, further comprising:
determining, by the controller, that the machine is traveling at a speed that exceeds a threshold speed,
wherein the controller broadcasts the identification data request in response to determining that the machine is traveling at the speed that exceeds the threshold speed.

4. The method of claim 2, further comprising:
determining, by the controller, that at least a second threshold period of time has elapsed since the controller last received data indicating a particular sensor address included in the sensor configuration,
wherein the controller broadcasts the identification data request in response to determining that at least the second threshold period of time has elapsed since the controller last received the data indicating the particular sensor address.

5. The method of claim 2, further comprising reducing, by the controller, a power used by the controller to listen for the identification data during the threshold period of time.

6. The method of claim 1, wherein:
the identification data, received from the sensor, has a configuration indicator, and
the controller determines that the sensor was likely in the configuration mode based on the configuration indicator of the identification data.

7. The method of claim 1, further comprising:
receiving, by the controller, user input defining a mounting location of the sensor,
wherein the entry added to the sensor configuration by the controller additionally indicates the mounting location defined by the user input.

8. The method of claim 1, wherein:
the identification data, received from the sensor, indicates a mounting location of the sensor, and
the entry added to the sensor configuration by the controller additionally indicates the mounting location indicated by the identification data.

9. The method of claim 1, wherein:
the identification data, received from the sensor, indicates one or more sensor attributes of the sensor, and
the entry added to the sensor configuration by the controller additionally indicates the one or more sensor attributes of the sensor.

10. A method comprising:
determining, by a sensor associated with a machine, activation of a configuration trigger of the sensor;
switching, by the sensor, and based on the activation of the configuration trigger, from a normal operation mode to a configuration mode; and
broadcasting, by the sensor, and while the sensor is in the configuration mode, identification data that indicates a sensor address of the sensor,
wherein the identification data causes a controller of the machine to update a sensor configuration to include an entry for the sensor address of the sensor.

11. The method of claim 10, wherein the identification data has a configuration indicator associated with the configuration mode.

12. The method of claim 10, wherein broadcasting the identification data while the sensor is in the configuration mode comprises broadcasting the identification data at a reduced power level, relative to a power level the sensor uses to broadcast the identification data while the sensor is in the normal operation mode.

13. The method of claim 10, wherein the configuration trigger comprises at least one of:
a hardware configuration trigger that is configured to be activated manually by a user or a user tool, or
a digital configuration trigger that is configured to be activated based on data from a user device.

14. The method of claim 10, wherein the configuration trigger comprises a digital configuration trigger that is configured to be activated by an identification data request broadcast by the controller.

15. The method of claim 14, further comprising:
detecting, by the sensor, motion of the sensor; and
initiating, by the sensor, active listening for the identification data request based on detecting the motion of the sensor.

16. The method of claim 10, further comprising:
receiving, by the sensor, user input defining a mounting location of the sensor,
wherein the identification data, broadcast by the sensor, indicates the mounting location of the sensor.

17. The method of claim 10, wherein the identification data, broadcast by the sensor, indicates one or more sensor attributes of the sensor.

18. A system comprising:
a controller of a machine, the controller being configured to:
maintain a sensor configuration indicating sensor addresses of individual sensors associated with the machine;
receive sensor data broadcast by sensors;
process instances of the sensor data that indicate the sensor addresses included in the sensor configuration;
receive identification data broadcast by the sensors; and
update the sensor configuration based on instances of the identification data broadcast while the sensors are in a configuration mode; and
a sensor associated with the machine, the sensor comprising a configuration trigger, wherein activation of the configuration trigger:
temporarily switches the sensor to operate in the configuration mode, and
causes the sensor to broadcast an instance of the identification data that indicates a sensor address of the sensor,
wherein the instance of the identification data broadcast by the sensor, while the sensor is in the configuration mode, causes the controller to update the sensor configuration by adding an entry including the sensor address of the sensor.

19. The system of claim 18, wherein the configuration trigger of the sensor comprises at least one of:
a hardware configuration trigger that is configured to be activated manually by a user or a user tool, or
a digital configuration trigger that is configured to be activated based on data from a user device.

20. The system of claim 18, wherein:
the configuration trigger of the sensor comprises a digital configuration trigger that is configured to be activated by an identification data request broadcast by the controller, and
the controller is configured to broadcast the identification data request based on at least one of:
a first determination that the machine is traveling at a speed that exceeds a threshold speed, or
a second determination that at least a threshold period of time has elapsed since the controller last received data indicating a particular sensor address included in the sensor configuration.
